(19) United States
(12) Patent Application Publication
(10) Pub. No.: US 2015/0105437 A1
(43) Pub. Date: Apr. 16, 2015

(54) Process for the Preparation of Random Radical Copolymers, and Active Substance Compositions Obtainable Therefrom

(71) Applicant: BASF SE, Ludwigshafen (DE)

(72) Inventors: Holger TUERK, Mannheim (DE); Cedric DIELEMAN, Scheibenhard (FR); Hans-Guenter BOHRMANN, Ludwigshafen (DE); Sebastian KOLTZENBURG, Dannstadt-Schauernheim (DE)

(21) Appl. No.: 14/519,307

(22) Filed: Oct. 21, 2014

Related U.S. Application Data
(63) Continuation of application No. 13/132,117, filed on Jun. 1, 2011, now abandoned.

(30) Foreign Application Priority Data
Dec. 2, 2008 (EP) 08170501.4

(51) Int. Cl. A01N 25/10; A01N 43/653; A01N 47/24; C08F 220/18

(52) U.S. Cl. CPC A01N 25/10; C08F 220/18; A01N 43/653; A01N 47/24
USPC 514/383; 526/212

(57) ABSTRACT

A process for the preparation of random radical copolymers which comprises
a) at least one olefinically unsaturated sulfonic acid of the formula (I),

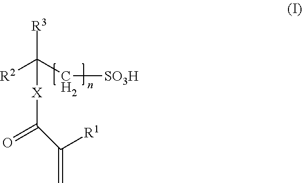

where
n is 0 to 10;
X is O or NR⁵;
R¹ is hydrogen or methyl;
R², R³ independently of one another are hydrogen or C₁- to C₆-alkyl and
R⁵ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
salts thereof or mixtures of acid and salts and
b) at least two structurally different olefinically unsaturated monomers of the formula (II),

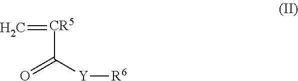

where
Y is O or NR⁷;
R⁵ is hydrogen or methyl;
R⁶ is alkyl, hydroxyalkyl, (di)alkylaminoalkyl or (di)alkylaminoaryl and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
and
c) if appropriate, one or more olefinically unsaturated monomers which differ structurally from components (a) and (b),
d) at least one initiator
   being dissolved either (i) in a solvent mixture comprising water and a water-soluble organic solvent with a boiling point of less than 140° C. or (ii) being dissolved in one or more pure alcohols by heating, and being polymerized in solution, where the polymer formed remains in solution. The copolymers which are obtainable by the process are suitable as formulation adjuvants in agrochemical active substance compositions.

The invention relates to a process for the preparation of random radical copolymers, to copolymers obtainable by the process, to agrochemical active substance compositions obtainable therefrom, to processes for their preparation, and to their use for controlling harmful organisms in plant protection.

Many active substances are ideally provided in the form of aqueous systems. Naturally, this makes difficult the effective application of active substances which are not, or are only sparingly, soluble in water since the bioavailability, and hence the biological activity are low. Many active substances, mainly in the agricultural and pharmaceutical sectors, are hydrophobic in nature and therefore suffer from the abovementioned application problem.

This is why active substances are frequently combined with a matrix in solution in order to give, in a spray-drying step, a solid active-substance formulation in the form of a composite powder, which can be dispersed in an aqueous medium.

Matrix materials which can be used are carbohydrates, proteins, inorganic salts, resins, lipids and olefinic polymers. It may be necessary to add further components such as stabilizers and surfactants to redisperse them.

WO 2005/046328 describes formulations which comprise a random radical copolymer in addition to one or more active substances. The copolymers described therein are prepared by copolymerizing 2-acrylamido-2-methyl-1-propanesulfonic acid (AMPS), n-alkyl acrylate and phenoxyethyl acrylate (POEA). The copolymerization is carried out in aprotic, dipolar solvents such as, for example, dimethylformamide (DMF), N-methylpyrrolidone (NMP) or dimethyl sulfoxide (DMSO) in the presence of an initiator for the free-radical polymerization, such as, for example, azobis(isobutyronitrile) (AIBN).

Although good results can be achieved with the above-described copolymers and their preparation processes, there is still room for improvement regarding the process control and the starting materials. In particular, it is desirable to obtain the synthetized copolymers free from residues of high-boiling organic solvents.

It is the object of the invention to provide a process for the preparation of a random radical copolymer with an improved profile of characteristics, where the copolymers obtained, and agrochemical active substance compositions comprising them are free from residues of high-boiling organic solvents.

It has been found that random radical copolymers based on sulfonic acid containing unsaturated monomers and alkyl acrylates are advantageously obtained by dissolving the monomers and the initiator used in a solvent mixture, comprising water and a water-soluble organic solvent with a boiling point of less than 140° C., or, with heating, in one or more pure alcohols, and polymerizing them in solution, where the polymer formed is also soluble.

EP-A 1 739 108 discloses thickeness for aqueous system based on sulfonic acid containing monomers, acrylic amides, hydrophobic (meth)acrylates and cross linking agents that have a molecular weight of 250,000 to 10,000,000 and are produced by precipitation polymerization with neutralization of the acid groups. Such thickeness are not suitable as dispersing agents for hydrophob agrochemical active ingredients.

The invention therefore relates to a process for the preparation of random radical copolymers where
a) at least one olefinically unsaturated sulfonic acid of the formula (I),

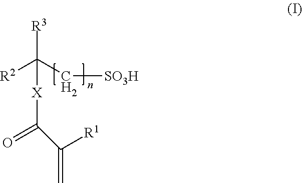

where
n is 0 to 10;
X is O or NR⁴;
R¹ is hydrogen or methyl;
R², R³ independently of one another are hydrogen or C₁- to C₆-alkyl and
R⁴ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
salts thereof or mixtures of acid and salts and
b) at least two structurally different olefinically unsaturated monomers of the formula (II),

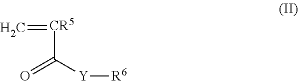

where
Y is O or NR⁷;
R⁵ is hydrogen or methyl;
R⁶ is alkyl, hydroxyalkyl or (di)alkylaminoalkyl and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
and
c) if appropriate, one or more olefinically unsaturated monomers which differ structurally from components (a) and (b),
d) at least one initiator
   are dissolved either (i) in a solvent mixture comprising water and a water-soluble organic solvent with a boiling point of less than 140° C. or (ii) are dissolved in one or more pure alcohols by heating, and are polymerized, preferably in solution, where the polymerformed is preferably also remains in solution.

The invention furthermore relates to novel random radical copolymers obtainable by the process according to the invention, to agrochemical active substance compositions obtainable therefrom, to a process for the preparation of these agrochemical active substance compositions, and to the use of the agrochemical active substance compositions for controlling harmful organisms in plant protection.

The process according to the invention gives copolymers and active substance compositions which are free from high-boiling organic solvents. Moreover, the copolymers according to the invention and active substance compositions obtainable therefrom feature an improved stability and better binding of the active substance to the polymer base.

According to the invention, all the boiling points mentioned relate to atmospheric pressure (1 bar).

The copolymers obtainable according to the invention generally show an average molecular weight M_{w} in the range of from 2,500 to 100,000, preferably 5,000 to 50,000, more preferred 5,000 to 30,000. The average molecular weight M_{N} is generally in the range of from 1,000 to 50,000, preferably 2,000 to 15,000.

The amount of free acid groups (based on the total amount of acid groups of components (a) and (c)) is preferably at least 50%, more preferred at least 70%, especially preferred 100%.

Preferred copolymers are those with an average molecular weight M_{w} in the range of from 2,500 to 100,000, preferably 5,000 to 50,000, more preferred 5,000 to 30,000 and an amount of free acid groups (based on the total amount of acid groups of components (a) and (c)) of at least 50%, preferably 70%, especially preferred 100%.

Suitable alkyl radicals for the olefinically unsaturated monomers of the formula (I) and of the formula (II), which are employed in the process according to the invention, are straight-chain, branched or cyclic C₁- to C₂₀-alkyl, alone or in combination. The following may be mentioned in particular: methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl, cyclohexyl, n-heptyl, n-octyl, 2-ethylhexyl, decyl, isodecyl, undecyl, dodecyl, tridecyl, tetradecyl, pentadecyl, hexadecyl, heptadecyl and octadecyl.

Suitable aryl radicals, alone or in combination, which may be mentioned are C₆-C₂₀-aryl. Unsubstituted mononuclear C₆- to C₁₀-aryls, unsubstituted polynuclear C₆- to C₁₀-aryls, and substituted mononuclear C₆- to C₁₀-aryls and substituted polynuclear C₆- to C₁₀-aryls, such as phenyl or naphthyl, may be mentioned in particular.

The stated ranges and preferences of the alkyl and aryl groups also apply to the corresponding composite functional groups comprising alkyl and/or aryl groups, such as alkylaryl, arylalkyl, alkoxy, aryloxy, hydroxyalkyl and substituted amino groups.

Suitable substituents of the aryl groups are, for example, halogen, (C₁-C₄)-alkyl, (C₁-C₄)-haloalkyl, (C₁-C₄)-alkoxy, (C₁-C₄)-haloalkoxy, OH, aryl and aryloxy, with phenyloxy being especially preferred.

Optionally employed monomers of component (c) are, for example, acrylic acid, methacrylic acid and vinylsulfonic acid, if appropriate also in salt form, vinylaromatic monomers such as styrene and styrene derivatives, for example α-methylstyrene, vinyltoluene, ortho-, meta- and para-methylstyrene, ethylvinylbenzene, vinylnaphthalene, vinylxylene and the corresponding halogenated vinyl-aromatic monomers, nitro-, alkoxy-, haloalkyl-, carbalkoxy-, carboxy-, amino- and alkylamino-group-bearing vinyl-aromatic monomers, α-olefins such as ethene, propene, 1-butene, 1-pentene, 1-hexene, isobutene, long-chain (C₁₀-C₂₀)alkyl-α-olefins, dienes such as butadiene and isoprene, vinyl alcohol esters such as vinyl acetate, vinyl halides such as vinyl chloride, vinyl bromide, vinyl fluoride, vinylidene chloride, vinylidene fluoride, vinylidene bromide, vinylnitrile, vinylcarboxylates, 1-vinylamides such as 1-vinylpyrrolidone, 1-vinylpiperidone, 1-vinylcaprolactam, 1-vinylformamide, 1-vinylacetamide or 1-methyl-1-vinylacetamide, N-vinylimidazole, C₁- to C₂₄-alkyl esters and mono- and disubstituted and unsubstituted C₁- to C₂₄-alkyl amides of fumaric, maleic and itaconic acid, anhydrides such as maleic anhydride, unsaturated aldehydes such as acrolein, unsaturated ethers such as 1,4-cyclohexanedimethanol divinyl ether, butanediol divinyl ether, butanediol monovinyl ether, cyclohexyl vinylether, diethylene glycol divinyl ether, butanediol monovinyl ether, ethylene glycol monovinyl ether, ethyl vinyl ether, methyl vinyl ether, n-butyl vinyl ether, octadecyl vinyl ether, triethylene glycol vinyl methyl ether, vinyl isobutyl ether, vinyl 2-ethylhexyl ether, vinyl propyl ether, vinyl isopropyl ether, vinyl dodecyl ether, vinyl tert-butyl ether, hexandiol divinyl ether, hexandiol monovinyl ether, diethylene glycol monovinyl ether, diethylaminoethyl vinyl ether, polytetrahydrofuran-290 divinyl ether, tetraethylene glycol divinyl ether, ethylene glycol butyl vinyl ether, ethylene glycol divinyl ether, triethylene glycol divinyl ether, trimethylolpropane trivinyl ether and aminopropyl vinyl ether.

A polymer referred to as being “free-radical” is understood as meaning a polymer prepared by free-radical polymerization.

A copolymer referred to as being “random” is understood as meaning a copolymer where the comonomers are incorporated in a random manner into the macromolecule resulting from the copolymerization. The same also applies to copolymers which consist of more than two types of monomer.

The sulfonic acids of the formula (I)—like other acids of components (c)—may exist in the acid or salt form, or as a mixture of the acid and salt forms, where the acid form is preferred as described above. Alternatively, it is possible to use the salt form of the monomers and subsequently to partially or fully protonate the acid groups of the monomer units incorporated in the polymer, or to use the acid form of the monomers and subsequently to partially or fully neutralize the acid groups of the monomer units incorporated in the polymer.

The term “sulfonic acid” or “acid” is used to represent all these forms.

Salts of sulfonic acid and of other acids are preferably metal salts, in particular alkali metal salts, such as lithium, sodium and potassium salts, or ammonium salts.

In a preferred embodiment, the process according to the invention employs
a) at least one olefinically unsaturated sulfonic acid of the formula (I),

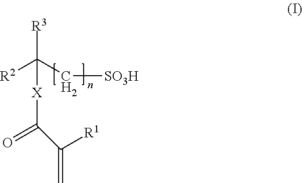

where
X is NH or oxygen;
R¹ is methyl or hydrogen;
R² and R³ are methyl or hydrogen and
n is 1,
b1) at least one olefinically unsaturated monomer of the formula (IIa),

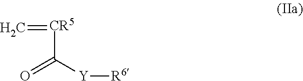

where
Y is oxygen or NR⁷;
R⁵ is hydrogen or methyl;
R^{6′} is C₁-C₆-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl and cyclohexyl, and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
b2) at least one olefinically unsaturated monomer of the formula (IIb),

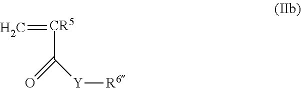

where
R⁵ is methyl or hydrogen and
R^{6″} is C₇-C₂₀-alkyl, such as n-heptyl, n-octyl, 2-ethylhexyl, decyl, isodecyl, undecyl, dodecyl, tridecyl, tetradecyl, pentadecyl, hexadecyl, heptadecyl, octadecyl and eicosyl,
c) if appropriate, one or more olefinically unsaturated monomers which differ structurally from components (a) and (b), and
d) at least one initiator.

In a more preferred embodiment, the process according to the invention employs
a) at least one olefinically unsaturated sulfonic acid of the formula (I),

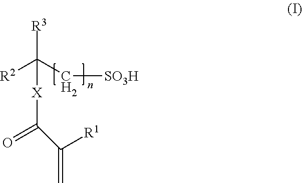

where
X is NH or oxygen;
R¹ is methyl or hydrogen;
R² and R³ are methyl or hydrogen and
n is 1,
b1) at least one olefinically unsaturated monomer of the formula (IIa),

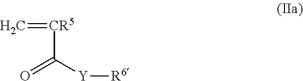

where
Y is oxygen or NR⁷;
R⁵ is hydrogen or methyl;
R^{6′} is C₁-C₆-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl and cyclohexyl, and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
b2) at least one olefinically unsaturated monomer of the formula (IIb),

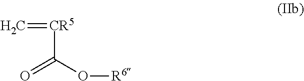

where
R⁵ is methyl or hydrogen and
R^{6″} is C₇-C₂₀-alkyl, such as n-heptyl, n-octyl, 2-ethylhexyl, decyl, isodecyl, undecyl, dodecyl, tridecyl, tetradecyl, pentadecyl, hexadecyl, heptadecyl, octadecyl and eicosyl,
c) if appropriate, one or more olefinically unsaturated monomers which differ structurally from components (a) and (b), from the group consisting of acrylic acid, methacrylic acid, vinylsulfonic acid, if appropriate also in salt form, styrene α-methylstyrene, vinyltoluene, ortho-, meta- and para-methylstyrene, ethylvinylbenzene, vinylnaphthalene, vinylxylene, ethene, propene, 1-butene, 1-pentene, 1-hexene, isobutene, long-chain (C₁₀-C₂₀)alkyl-α-olefins, butadiene, isoprene, vinyl acetate, vinyl chloride, vinyl bromide, vinyl fluoride, vinylidene chloride, vinylidene fluoride, vinylidene bromide, vinylnitrile, vinylcarboxylates, 1-vinylpyrrolidone, 1-vinylpiperidone, 1-vinylcaprolactam, 1-vinylformamide, 1-vinylacetamide or 1-methyl-1-vinylacetamide, N-vinylimidazole, C₁- to C₂₄-alkyl esters and mono- and disubstituted and unsubstituted to C₂₄-alkyl amides of fumaric, maleic and itaconic acid, maleic anhydride, acrolein, butanediol monovinyl ether, cyclohexyl vinylether, butanediol monovinyl ether, ethylene glycol monovinyl ether, ethyl vinyl ether, methyl vinyl ether, n-butyl vinyl ether, octadecyl vinyl ether, triethylene glycol vinyl methyl ether, vinyl isobutyl ether, vinyl 2-ethylhexyl ether, vinyl propyl ether, vinyl isopropyl ether, vinyl dodecyl ether, vinyl tert-butyl ether, hexandiol monovinyl ether, diethylene glycol monovinyl ether, diethylaminoethyl vinyl ether, ethylene glycol butyl vinyl ether, and aminopropyl vinyl ether, as well as (d?)
d) at least one initiator.

In an especially preferred embodiment, the process according to the invention employs
a) at least one olefinically unsaturated sulfonic acid of the formula (I),

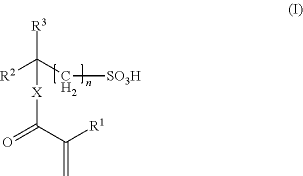

where
X is NH or oxygen;
R¹ is methyl or hydrogen;
R² and R³ are methyl or hydrogen and
n is 1,
b1) at least one olefinically unsaturated monomer of the formula (IIa),

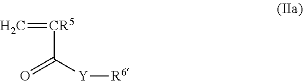

where
Y is oxygen
R⁵ is hydrogen or methyl;
R^{6′} is C₁-C₆-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl and cyclohexyl, and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
b2) at least one, preferably two, olefinically unsaturated monomers of the formula (IIb),

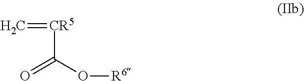

where
R⁵ is methyl or hydrogen and
R^{6″} is C₇-C₂₀-alkyl, such as n-heptyl, n-octyl, 2-ethylhexyl, decyl, isodecyl, undecyl, dodecyl, tridecyl, tetradecyl, pentadecyl, hexadecyl, heptadecyl, octadecyl and eicosyl,
c) if appropriate, one or more olefinically unsaturated monomers which differ structurally from components (a) and (b), from the group consisting of acrylic acid, methacrylic acid, vinylsulfonic acid, if appropriate also in salt form, styrene, α-methylstyrene, vinyltoluene, ortho-, meta- and para-methylstyrene, ethylvinylbenzene, vinylnaphthalene, vinylxylene, vinyl acetate, vinyl chloride, vinyl bromide, vinyl fluoride, vinylidene chloride, vinylidene fluoride, vinylidene bromide, vinylnitrile, vinylcarboxylates, 1-vinylpyrrolidone, 1-vinylpiperidone, 1-vinylcaprolactam, 1-vinylformamide, 1-vinylacetamide, 1-methyl-1-vinylacetamide, N-vinylimidazole, C₁- to C₂₄-alkyl esters and mono- and disubstituted and unsubstituted C₁- to C₂₄-alkyl amides of fumaric, maleic and itaconic acid, and maleic anhydride.
d) at least one initiator.

In a further preferred embodiment, two structurally different olefinically unsaturated monomers, (b2′) and (b2″), of the formula (IIb) are employed as component (b2).

In an especially preferred embodiment, an olefinically unsaturated monomer of the formula (IIb) which comprises, as substituent R^{6″}, an alkyl radical having 7 to 12 C atoms is employed as monomer component (b2′), and an olefinically unsaturated monomer of the formula (IIb) which comprises, as substituent R^{6″}, an alkyl radical having 13 to 20 C atoms is employed as monomer component (b2″).

Copolymers with more than three components may be prepared by using two different monomers (b2). This allows the amphiphilicity, and thus the dispersibility of the macromolecules, to be adapted better to the respective requirements with regard to the use in agrochemical active substance formulations than would be the case in the synthesis of ternary copolymers.

Moreover, this can be achieved particularly successfully by the very especially preferred use of an olefinically unsaturated monomer of the formula (IIb) which comprises, as substituent R^{6″}, an alkyl radical having 7 to 12 C atoms and of an olefinically unsaturated monomer of the formula (IIb) which comprises, as substituent R^{6″}, an alkyl radical having 13 to 20 C atoms.

In a further preferred embodiment, acrylic acid and/or methacrylic acid are employed as component (c).

In a further preferred embodiment, no aryloxyacrylates and -methacrylates are employed as component (c).

In an especially preferred embodiment, exclusively compounds of the formulae (I) and (II), in particular of the formulae (I), (IIa) and (IIb), are employed as starting monomers.

In a further especially preferred embodiment, the process according to the invention employs
a) at least one olefinically unsaturated sulfonic acid from the group consisting of 2-acrylamido-2-methyl-propane sulfonic acid (AMPS) (Ia) (this results from the formula (I) where X=NH, R¹=hydrogen, R²=R³=methyl and n=1) and 2-sulfoethyl methacrylate (SEMA) (Ib) (this results from the formula (I) where X=oxygen, R¹=methyl, R²=R³=hydrogen, n=1)

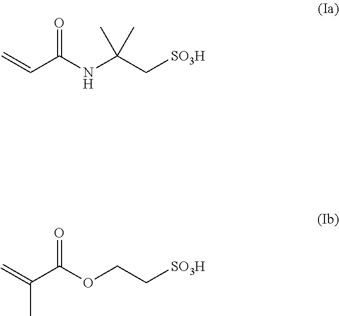

b1) at least one olefinically unsaturated monomer of the formula (IIa),
   where
   Y is oxygen;
   R⁴ is hydrogen or methyl and
   R^{6′} is methyl, ethyl, propyl or butyl,
b2) at least one, preferably at least two, olefinically unsaturated monomers of the formula (IIb),
   where
   Y is oxygen;
   R¹⁰ is hydrogen and
   R^{6″} is dodecyl, tetradecyl, hexadecyl, octadecyl or eicosyl,
c) if appropriate, acrylic acid and/or methacrylic acid, and
d) at least one initiator.

In a preferred embodiment, component (a) is employed in mixing ratios of from 10 to 80% by weight, especially preferably from 25 to 70% by weight, particularly preferably of from 30 to 65% by weight, component (b1) in mixing ratios of from 20 to 88% by weight, component (b2) in mixing ratios of from 2 to 30% by weight, and component (c) in mixing ratios of from 0 to 50% by weight, based on the total amount of the starting monomers.

In an especially preferred embodiment, component (a) is employed in mixing ratios of from 20 to 60% by weight, component (b1) in mixing ratios of from 30 to 80% by weight, component (b2) in mixing ratios of from 5 to 25% by weight, and component (c) in mixing ratios of from 0 to 40% by weight.

Preferably, the total amount of monomers (a) and (c) which bear an acid group amounts to from 20 to 60% by weight.

In a further especially preferred embodiment, SEMA (Ib) is employed as component (a), methyl methacrylate (MMA) as component (b1), dodecyl acrylate and/or a further hydrophobic acrylate in which R^{6″} is C₁₃-C₂₀-alkyl is/are employed as component (b2), and, if appropriate, acrylic acid and/or methacrylic acid is/are employed as component (c).

In a further especially preferred embodiment, AMPS (Ia) is employed as component (a), MMA as component (b1) and dodecyl acrylate and/or a further hydrophobic acrylate in which R^{6″} is C₁₃-C₂₀-alkyl is/are employed as component (b2), and, if appropriate, acrylic acid and/or methacrylic acid is/are employed as component (c) in the process according to the invention.

In an especially preferred embodiment, SEMA (Ib) is employed as component (a), MMA as component (b1) and dodecyl acrylate and a further hydrophobic acrylate in which R^{6″} is C₁₃-C₂₀-alkyl is/are employed as component (b2), and, if appropriate, acrylic acid and/or methacrylic acid is/are employed as component (c) in the process according to the invention.

In a further especially preferred embodiment, AMPS (Ia) is employed as component (a), MMA as component (b1) and dodecyl acrylate and a further hydrophobic acrylate in which R^{6″} is C₁₃-C₂₀-alkyl is/are employed as component (b2), and, if appropriate, acrylic acid and/or methacrylic acid is/are employed as component (c) in the process according to the invention.

According to the invention, the random radical copolymers are obtained by free-radical polymerization either (i) in a solvent mixture consisting of water and at least one organic solvent with a boiling point <140° C. or (ii) in one or more pure alcohols. It is possible to employ the customary processes for free or controlled, preferably free, free-radical polymerization, the reaction mixture comprising at least one initiator.

The solvent mixture is preferably chosen such that components (a), (b), (d) and, if appropriate, (c) and the copolymer formed are soluble.

For the purposes of the invention, the term soluble comprises both a true solution and a dispersion which is so finely distributed that no turbidity is formed.

The polymerization can be carried out as a batch reaction, as a semi-continuous or a continuous operation.

In general, the reaction times are in the range between 1 and 48 h, preferably in the range of from 2 to 24 h and particularly preferably in the range of from 4 to 24 h. The temperature range within which the reaction can be carried out is, in general, from 20 to 200° C., preferably from 30 to 120° C. and especially preferably from 40 to 90° C.

Suitable polymerization concentrations are in the range from 1-50% by weight, preferably in the range of from 10-40% by weight, especially preferably in the range of from 15-35% by weight. The polymerization concentration is understood as meaning the weight of all the monomers employed (components (a), (b) and, if appropriate, (c)) based on the total weight of all substances involved in the process, i.e. the total of all the monomers employed (components (a), (b) and, if appropriate, (c)), of the initiator, of the solvents and, if appropriate, of the further adjuvants and additives.

Customary free-radical formers are employed as initiator (component (d)) for the free-radical polymerization. The initiator is preferably selected from the group of the azo compounds, of the peroxide compounds or of the hydroperoxide compounds. Examples which may be mentioned are acetyl peroxide, benzoyl peroxide, lauroyl peroxide, tert-butyl peroxyisobutyrate, caproyl peroxide, cumene hydroperoxide, azobis(isobutyronitrile), 2,2-azobis(2-methylbutyronitrile), 2,2′-azobis(2-methylpropionamidine) dihydrochloride and 2,2′-azobis[2-(2-imidazolin-2-yl)propane]dihydrochloride. Naturally, mixtures of initiators may also be employed.

It is especially preferred to select the initiator from the group consisting of 2,2′-azobis(2-methylbutyronitrile) (commercially available from Wako Chemicals USA Inc. under the trade name WAKO® V-59), 2,2′-azobis(2,4-dimethylvaleronitrile) (commercially available from Wako Chemicals USA Inc. under the trade name WAKO® V-65), 2,2′-azobis(4-methoxy-2,4-dimethylvaleronitrile) (commercially available from Wako Chemicals USA Inc. under the trade name WAKO® V-70), 2,2′-azobis[2-(2-imidazolin-2-yl)propane]dihydrochloride (commercially available from Wako Chemicals USA Inc. under the trade name WAKO® VA-044), 2,2′-azobis(2-methylpropionamidine) dihydrochloride (commercially available from Wako Chemicals USA Inc. under the trade name WAKO® V-50) and 2,2′-azobis(isobutyronitrile) (AIBN). 2,2′-Azobis(2-methylbutyronitrile) (WAKO® V-59) and 2,2′-azobis(isobutyronitrile) (AIBN) are the most preferred.

The polymerization is carried out in solution.

According to a first variant of the process according to the invention, the polymerization is carried out in a solvent mixture comprising water and at least one water-soluble organic solvent with a boiling point of less than 140° C. (variant (i)). Variant (i) is preferred.

According to a further variant of the process according to the invention, the polymerization is carried out in one or more pure alcohols (variant (ii)).

Within the scope of the invention, the term solvent mixture “comprising water” is understood as meaning that at least 1% by weight of water, based on the total weight of all of the substances involved in the process, i.e. based on the total of all the monomers employed (components (a), (b) and, if appropriate, (c)) based on the total weight of all substances involved in the process, i.e. the total of all the monomers employed (components (a), (b) and, if appropriate, (c)), of the initiator, of the solvents and, if appropriate, of the further adjuvants and additives is present in the reaction mixture. It is preferred that from 1 to 80% by weight, more preferred from 1 to 50% by weight, especially preferred from 1 to 30% by weight, in particular from 5 to 35% by weight, of water are present.

Suitable organic solvents are, in principle, all solvents with a boiling point of less than 140° C. Preferred solvents are those which are miscible with water and which have a boiling point 120° C. Especially preferred organic solvents are alcohols, ethers and nitriles. Especially preferred alcohols which may be mentioned by way of example are methanol, ethanol, n-propanol (1-propanol), isopropanol (2-propanol), n-butanol (1-butanol), sec-butanol (2-butanol), tert-butanol (2-methylpropan-2-ol), 1-pentanol, 2-pentanol, 3-pentanol, 2-methylbutanol, 3-methylbutan-2-ol and 2,2-dimethylpropanol.

Very especially preferred alcohols are methanol, ethanol, n-propanol (1-propanol) and isopropanol (2-propanol). Isopropanol (2-propanol) is particularly preferred.

Ethers which are suitable are, in principle, all simple or mixed ethers which can be prepared by reacting the abovementioned alcohols. Cyclic ethers such as tetrahydrofuran, tetrahydropyran and dioxane are furthermore suitable. Especially suitable ethers are diethyl ether, tetrahydrofuran and dioxane. Tetrahydrofuran is particularly suitable, in particular as cosolvent.

Suitable nitriles are acetonitrile and propionitrile. Acetonitrile is especially suitable.

Preferred solvent mixtures are, firstly, binary mixtures of water and an alcohol. A binary mixture of water and isopropanol or of water and methanol is especially preferred. A binary mixture of water and isopropanol (2-propanol) is particularly preferred.

Preferred are, secondly, ternary mixtures of water, an alcohol and an ether, with the mixture of water, isopropanol and tetrahydrofuran being especially preferred.

Sulfonic acids of the formula (I) (component (a)), such as AMPS (Ia) and SEMA (Ib) are water-soluble owing to their strong polarity. Acrylates of the formula (II) (component (b)) are largely insoluble in water, but are alcohol-soluble. Initiators (component (d)) are soluble either in water, in alcohols or in ethers, depending on their polarity.

In a preferred embodiment of the process (P1), the first step is to prepare four separate solutions using the above-described solvents or binary or ternary mixtures of these, with solution 1 comprising component (a) solution 2 comprising component (b1) solution 3 comprising component (b2) and solution 4 comprising component (d). These solutions are subsequently fed to a polymerization reactor and polymerized by known methods with which the skilled worker is familiar. A suitable solvent or a binary or ternary solvent mixture may first be introduced into the polymerization reactor.

In a further embodiment (P2), the first step is to prepare three separate solutions using the above-described solvents or binary or ternary mixtures of these, with solution 1 comprising component (a), solution 2 comprising components (b) and solution 3 comprising component (d). These solutions are subsequently fed to a polymerization reactor and polymerized in the above-described manner.

In a further embodiment (P3), the first step is to prepare two separate solutions using the above-described solvents or binary or ternary mixtures of these, with solution 1 comprising components (a), (b) and, if appropriate, (c) and solution 2 comprising component (d). These solutions are subsequently fed to the polymerization reactor and polymerized in the above-described manner. In a particular embodiment, solution 1 is prepared by carefully mixing two solutions 1a (component (a)) and 1b (component (b)) with each other.

In a further embodiment (P4), components (a), (b), and, if appropriate, (c) and (d) are jointly dissolved in a suitable binary or ternary solvent mixture of the above-described solvents and polymerized by known methods with which the skilled worker is familiar.

In a preferred embodiment of (P3), the first step is to prepare two solutions. Solution 1 comprises components (a), (b) and, if appropriate, (c) in a mixture of water with alcohol and/or THF, with isopropanol being especially preferred as the alcohol. Solution 2 comprises an initiator, preferably selected from the group consisting of AIBN, 2,2′-azobis(2-methylbutyronitrile), 2,2′-azobis(2,4-dimethylvaleronitrile), 2,2′-azobis(4-methoxy-2,4-dimethylvaleronitrile), 2,2′-azobis[2-(2-imidazolin-2-yl)propane]dihydrochloride and 2,2′-azobis(2-methylpropionamidine) dihydrochloride, with tetrahydrofuran (THF) or a mixture of tetrahydrofuran and isopropanol being especially preferred as solvent for AIBN and isopropanol being especially preferred for 2,2′-azobis(2-methylbutyronitrile), 2,2′-azobis(2,4-dimethylvaleronitrile), 2,2′-azobis(4-methoxy-2,4-dimethylvaleronitrile). Water or a mixture of water with isopropanol and/or THF are especially preferred for 2,2′-azobis[2-(2-imidazolin-2-yl)propane]dihydrochloride and 2,2′-azobis(2-methylpropionamidine) dihydrochloride.

Solution 1 and solution 2 are then introduced into a polymerization reactor which comprises isopropanol and/or THF or water or a mixture of water with isopropanol and/or THF and are polymerized at temperatures of from 40 to 90° C.

In a further embodiment (P5), components (a), (b) and, if appropriate, (c) are mixed in a pure alcohol with heating until a clear solution or suspension has formed, and subsequently polymerized by adding component (d). Pure alcohols are understood as meaning, in accordance with the invention, those alcohols which comprise less than 1% by weight, preferably less than 0.7% by weight, especially preferably less than 0.5% by weight, particularly preferably less than 0.3% by weight, and most preferably 0.1% by weight, of impurities. Heating means, in accordance with the invention, that the alcohol and components (a), (b) and, if appropriate, (c) are heated to temperatures in the range of from above room temperature (20° C.) to the boiling point at atmospheric pressure. When using pressurized reactors, it is, of course, also possible to heat the alcohol beyond the boiling point.

Suitable pure alcohols are, in principle, all alcohols with a boiling point of less than 140° C. Preferred alcohols are methanol, ethanol, n-propanol (1-propanol) and isopropanol (2-propanol). Isopropanol (2-propanol) is especially preferred.

In a further embodiment (P6), component (a) is introduced into, and dissolved or suspended in, methanol or isopropanol or water or mixtures of these, which, if appropriate, also comprise THF. After a clear solution or suspension has been formed by heating, components (b), if appropriate (c), and (d) are added jointly or separately, and the mixture is polymerized by known methods with which the skilled worker is familiar.

Variants P2, P3 and P6 are preferred. Variants P2 and P3, in particular variant P3, are particularly preferred.

The polydispersity and the molecular weight of the random radical copolymer can, if desired, be adjusted by varying the initiator/monomer ratio, the feed time of the substrates, in particular the feed time of the initiator solution in comparison with the feed time of the monomer solution(s), by varying the alcohol, in particular the isopropanol, content in the solvent mixture, and by the polymerization concentration. If a short initiator feed time and/or a high isopropanol content (regulator) in the solvent mixture and/or a low polymerization concentration (high regulator/monomer ratio) are chosen, then the result will, as a rule, be lower polydispersities.

According to the invention, one aims at the narrowest possible molecular weight distribution since copolymers with higher molar masses are, as a rule, less soluble in water, whereby the stability of the agrochemical active substance compositions is sometimes reduced.

If desired, the polydispersity of the copolymer can be reduced further by using additional regulators selected from the group of the mercaptans, such as mercaptoethanol, thioglycerol or 1-dodecylmercaptan.

The molar masses M_{w} and Mₙ and the polydispersity are determined by size-exclusion chromatography. Calibrating agents which may be used are commercially available polystyrene or poly(ethylene oxide) calibration means.

The solubility of the polymer in water can be adjusted by modifying the monomer composition. In particular, increasing the proportion of the hydrophilic sulfonic acid of the formula (I) (component (a)), such as AMPS (Ia) or SEMA (Ib), leads to an improved solubility in water and an improved dispersibility of the copolymer synthesized. Solubility in water and dispersibility of the copolymer synthesized can also be adapted to suit the specific requirements by choosing two different hydrophobic monomers b2′ and b2″.

When the copolymers according to the invention are prepared, the formation of 2-amino-2-methylpropanesulfonic acid can be observed to some extent as the result of the partial hydrolysis of AMPS. This may lead to turbidity in the reaction mixtures. This by-product is generated as a zwitterion and can be separated from the copolymer by customary preparative methods, such as precipitation and filtration. The formation of 2-amino-2-methylpropanesulfonic acid can take place both from the monomer and from the copolymer at elevated temperature and in the presence of polar, protic solvents such as water or alcohols. Accordingly, it is possible, by subjecting the incorporated AMPS to targeted hydrolysis, to control the proportion of repeating AMPS monomer units and the proportion of repeating acrylic acid monomer units in the copolymer. Naturally, it is also possible to adjust the proportion of repeating acrylic acid and acrylic ester monomer units in the copolymer by targeted hydrolysis or esterification. This opens up the possibility of controlling the solubility in water or the dispersibility of the copolymer.

If desired, the copolymer can be isolated and worked up. Work-up is carried out in the known manner with which the skilled worker is familiar, for example by a preceding filtration step. If appropriate, the by-product 2-amino-2-methylpropanesulfonic acid can thereby be removed. If desired, the solvent can subsequently be removed. Customary methods for removing the solvents are, for example, spray drying, evaporation at reduced pressure, freeze-drying and evaporation under atmospheric pressure at elevated temperature, if appropriate. The methods suitable for drying furthermore include drying in a fluidized-bed dryer. It is also possible to use the copolymer solution obtainable by the process further without work-up.

The invention also comprises the following random radical copolymers, which are obtainable by the process according to the invention.

The invention therefore relates to a random radical copolymer, obtainable by polymerizing, in particular by the process according to the invention,
a) at least one olefinically unsaturated sulfonic acid of the formula (I),

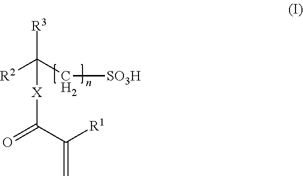

where
X is NH or oxygen;
R¹ is methyl or hydrogen;
R² and R³ are methyl or hydrogen and
n is 1,
b1) at least one olefinically unsaturated monomer of the formula (IIa),

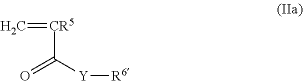

where
Y is oxygen or NR⁷;
R⁵ is hydrogen or methyl;
R^{6′} is C₁-C₆-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 1,1,2-trimethylpropyl, 1,2,2-trimethylpropyl, 1-ethyl-1-methylpropyl, 1-ethyl-2-methylpropyl and cyclohexyl, and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
b2) at least one olefinically unsaturated monomer of the formula (IIb),

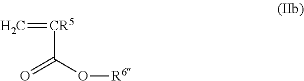

where
R⁵ is methyl or hydrogen and
R^{6″} is C₇-C₂₀-alkyl, such as n-heptyl, n-octyl, 2-ethylhexyl, decyl, isodecyl, undecyl, dodecyl, tridecyl, tetradecyl, pentadecyl, hexadecyl, heptadecyl, octadecyl, nonadecyl and eicosyl,
c) if appropriate, and at least one further olefinically unsaturated monomer which differs structurally from components (a) and (b).

The copolymers of the invention, preferably obtainable according to the invention, generally show an average molecular weight M_{w} in the range of from 2,500 to 100,000, preferably 5,000 to 50,000, more preferred 5,000 to 30,000. The average molecular weight M_{N} is generally in the range of from 1,000 to 50,000, preferably 2,000 to 15,000.

Preferred copolymers are further those obtainable by the use of the above referenced preferred monomer components.

The amount of free acid groups (based on the total amount of acid groups of components (a) and (c)) is preferably at least 50%, more preferred at least 70%, especially preferred 100%.

Preferred copolymers are those with an average molecular weight M_{w} in the range of from 2,500 to 100,000, preferably 5,000 to 50,000, more preferred 5,000 to 30,000 and an amount of free acid groups (based on the total amount of acid groups of components (a) and (c)) of at least 50%, preferably 70%, especially preferred 100%. Especially preferred these copolymers are obtainable from the above referenced preferred, more preferred and especially preferred monomer components.

Preferred, especially preferred and particularly preferred as olefinically unsaturated sulfonic acid (component a)) are 2-acrylamido-2-methylpropane sulfonic acid (AMPS) and 2-sulfoethyl methylacrylate (SEMA).

Preferred as olefinically unsaturated monomer of the formula (IIa) (component b1)) are compounds of the formula (IIa)

in which
Y is oxygen or NR⁷;
R⁵ is hydrogen or methyl;
R⁶ is (C₁-C₄)-alkyl and
R⁷ is hydrogen or (C₁-C₆)-alkyl.

Especially preferred are compounds of the formula (IIa)

in which
Y is oxygen;
R⁵ is hydrogen or methyl and
R⁶ is (C₁-C₄)-alkyl.

Particularly preferred are compounds of the formula (IIa)

in which
Y is oxygen;
R⁵ is methyl and
R⁶ is (C₁-C₄)-alkyl.

Preferred as olefinically unsaturated monomer of the formula (IIb) (component (b2)) are compounds of the formula (IIb)

in which
Y is oxygen;
R⁵ hydrogen or methyl and
R⁶ is (C₁₀-C₂₀)-alkyl.

Especially preferred are compounds of the formula (IIb)

in which
Y is oxygen;
R⁵ is hydrogen or methyl and
R⁶ is decyl, dodecyl, tetradecyl, hexadecyl, octadecyl or eicosyl.

Particularly preferred are compounds of the formula (IIb)

in which
Y is oxygen;
R⁵ is hydrogen and
R⁶ is dodecyl, tetradecyl, hexadecyl or octadecyl.

Preferred, especially preferred and particularly preferred as compounds of component (c) are acrylic acid and methacrylic acid.

It is preferred not to employ further monomers from the group consisting of the α-olefins (such as ethene, propene, 1-butene, 1-pentene, 1-hexene, isobutene), long-chain (C₁₀-C₂₀)alkyl-α-olefins, dienes (such as butadiene and isoprene), vinyl halides (such as vinyl chloride, vinyl bromide, vinyl fluoride, vinylidene chloride, vinylidene fluoride, vinylidene bromide), vinyl nitrile, vinyl carboxylates, unsaturated aldehydes (such as acrolein) for the polymerization of the copolymer according to the invention.

In one embodiment, it is preferred to employ vinyl-aromatic monomers (c) (such as styrene and styrene derivatives, for example α-methylstyrene, vinyltoluene, ortho-, meta- and para-methylstyrene, ethylvinylbenzene, vinylnaphthalene, vinylxylene and the corresponding halogenated vinyl-aromatic monomers), vinylsulfonic acid, 1-vinylamides (such as 1-vinylpyrrolidone, 1-vinylpiperidone, 1-vinylcaprolactam, 1-vinylformamide, 1-vinylacetamide or 1-methyl-1-vinylacetamide, n-vinylimidazole), anhydrides (such as maleic anhydride), vinyl alcohol esters (such as vinyl acetate) for polymerizing the copolymer according to the invention.

In particular, it is preferred to employ no further olefinically unsaturated monomers (c), besides acrylic acid and/or methacrylic acid, for the polymerization.

Preferred is a copolymer according to the invention which is obtainable by the polymerization of at least two monomers of the formula (IIb). It is preferred, especially preferred and particularly preferred in this embodiment that components (a), (b1), (b2) and (c) have the preferred, especially preferred and particularly preferred meanings, respectively.

Preferred is furthermore a copolymer according to the invention which is obtainable by the polymerization of in each case one monomer of components (a), (b1) and (b2) and, if appropriate, one, preferably no, further monomer of component (c). It is preferred, especially preferred and particularly preferred in this embodiment that components (a), (b1), (b2) and (c) have the preferred, especially preferred and particularly preferred meanings, respectively.

Equally preferred is a copolymer according to the invention which is obtainable by the polymerization of in each case one monomer of components (a) and (b1), two monomers of component (b2), especially preferably one monomer (b2) in which R^{6″} is C₁₂-alkyl and one monomer (b2) in which R^{6″} is C₁₃-C₂₀-alkyl, and, if appropriate, one or two monomers of component (c). It is preferred, especially preferred and particularly preferred in this embodiment that components (a), (b1), (b2) and (c) have the preferred, especially preferred and particularly preferred meanings, respectively.

In a preferred embodiment, the copolymers according to the invention comprise component (a) in mixing ratios of from 10 to 80% by weight, especially preferably from 25 to 70% by weight, particularly preferably from 30 to 65% by weight, component (b1) in mixing ratios of from 20 to 90% by weight, components (b2) in mixing ratios of from 2 to 30% by weight, and component (c) in mixing ratios of from 0 to 50% by weight, in each case based on the total weight of the copolymer.

In an especially preferred embodiment, the copolymers according to the invention comprise component (a) in mixing ratios of from 20 to 60% by weight, component (b1) in mixing ratios of from 30 to 80% by weight, components (b2) in mixing ratios of from 5 to 25% by weight and component (c) in mixing ratios of from 0 to 40, preferably 0 to 20, % by weight, in each case based on the total weight of the copolymer.

The amount of monomers (a) and (c) with an acid group preferably amounts to from 10 to 60% by weight, in particular 20 to 60% by weight.

In a preferred embodiment, the copolymers according to the invention comprise, as component, two monomers of component (b2), where R^{6″} is, on the one hand, C₇-C₁₂-alkyl and, on the other hand, C₁₃-C₂₀-alkyl. It is preferred, especially preferred and particularly preferred in this embodiment that components (a), (b1), (b2) and (c) have the preferred, especially preferred and particularly preferred meanings, respectively.

The copolymers according to the invention and also those obtainable in accordance with the invention are suitable for use in agrochemical active substance compositions.

The term agrochemical active substances (hereinbelow abbreviated to “active substances”) is used according to the invention to refer to fungicides, insecticides (which term comprises according to the invention not only insecticides in the narrow sense, but also acaricides, nematicides and molluscicides), herbicides (comprising growth regulators) and bactericides (in as far as they are employed in plant protection).

Agrochemical active substance compositions according to the invention can be prepared in a manner known per se and depends in a manner known per se on the nature of the composition. Processes herefor are known, for example, from U.S. Pat. No. 3,060,084, EP-A 707445, Browning, “Agglomeration”, Chemical Engineering, Dec. 4, 1967, 147-148, Perry's Chemical Engineer's Handbook, 4th ed., McGraw-Hill, New York, 1963, pp. 8-57, WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, “Weed Control as a Science”, John Wiley and Sons, New York 1961, Hance et al. Weed Control Handbook, 8^{th} ed. Blackwell Scientific Publications, Oxford 1989, H. Mollet et al., “Formulation Technology”, Wiley VCH-Verlag, Weinheim, 2001, and from the processes described in WO 2005/121201 and WO 2006/084680.

The term “agrochemical active substance composition” comprises according to the invention not only formulations, i.e. compositions, which comprise the active substance in concentrated form, but also aqueous ready-to-use compositions (use forms, in particular aqueous dispersions), which comprise the active substance in dilute form.

The invention also relates to a process for the preparation of an agrochemical active substance composition. To this end, it is preferred to dissolve one or more copolymers according to the invention and at least one plant protectant and, if appropriate, further additives separately from one another in identical or different solvents, preferably solvents which are miscible with one another, and to mix the resulting solutions with one another, if appropriate with addition of further additives. The solvent can be removed by one of the abovementioned methods in a second step. However, removal of the solvents is not absolutely necessary.

In a further embodiment of the process according to the invention, a joint solution of the copolymer and of at least one active substance and, optionally, further additives is prepared by providing one of the components in solvent-dissolved form and adding and dissolving the further components. Removal of the solvent can be carried out in a subsequent step by the above-described methods.

To this end, the copolymer is, for example, dissolved as an aqueous solution, at least one active substance is dissolved in one or more organic solvents which is/are miscible with water, and the solutions are mixed with one another. Further additives can optionally be added, and the active substance composition can be obtained in dispersed form by applying shear forces. Thereafter, the solvents are removed in a customary manner.

In this context, miscible with water means that the organic solvents are miscible with water to at least 10% by weight, preferably to 15% by weight, especially preferably to 20% by weight, without phase separation occurring.

Provision of energy can be advantageous for obtaining fine particles on mixing the aqueous and organic phases, for example the application of shear forces by high-frequency and high-amplitude shaking, high-frequency stirring, turbine agitation, or by using a mixing chamber. Mixing can be performed continuously or batchwise. Continuous mixing is preferred. The dispersion obtained in this manner can be freed from the solvents in the customary manner as explained above.

Suitable solvents for preparing the active substance composition are, for example, mixtures of alkylaromatics, especially alkylbenzenes and alkylnaphthalenes which bear alkyl groups having 1 to 20 carbon atoms. Such mixtures are commercially available, for example Solvesso®, such as Solvesso 200 (Exxon Mobil, USA), aromatics, for example Aromatic 200 (Exxon Mobil), or Shellsol® products (Deutsche Shell Chemie GmbH, Germany). Other suitable organic solvents are paraffins, alcohols, pyrrolidones, acetates, glycols, fatty acids, dimethylamides, fatty acid dimethylamides, fatty acid esters, vegetable oils such as coconut oil, palm kernel oil, palm oil, soya oil, rapeseed oil, corn oil, and the methyl or ethyl esters of the abovementioned oils, and mixtures of these. Further suitable solvents are tributyl phosphate, methanol, ethanol, isopropanol, 1-butanol, 2-butanol, tert-butanol, pentanol, hexanol, 2-ethylhexanol, 1,3-dimethyl-2-imidazolinone, 2-methyl-2,4-pentanediol, acetone, acetophenone, propanoic acid, 2-hydroxy-2-ethyl hexyl ester, di-n-octyl carbonate, ethylene carbonate, propylene carbonate, butylene carbonate, dibasic esters such as dimethyl adipate, dimethyl succinate, dimethyl glutarate and their mixtures, or diisobutyl derivatives of benzyl acetate, benzyl alcohol, benzyl benzoate, cyclohexane, cyclohexanol, cyclohexanone, butyl lactate, 2-ethylhexyl lactate, ethyl lactate, methyl lactate, n-propyl lactate, tetrahydrofurfuryl alcohol, xylene, diethylene glycol, dimethylformamide, dimethyl sulfoxide, dipropylene glycol, 5-methyl-3-heptanone, glycols and derivatives such as, for example, polyethylene glycol, glycerol, propylene glycol, propylene glycol monomethyl ether acetate, dipropylene glycol monomethyl ether, propylene glycol monophenyl ether; butyrolactone, glycerol, methyl benzoate, n-ethyl-2-pyrrolidone, n-methylcaprolactam, n-octyl-2-pyrrolidone, propanoic acid, and ethers such as tetrahydrofuran and dioxane, water, and mixtures of these solvents, esters, ketones such as acetone, methyl ethyl ketone, methyl isopropyl ketone, methyl isobutyl ketone, acetals, ethers, cyclic ethers such as tetrahydrofuran, aliphatic carboxylic acids such as formic acid, acetic acid, propionic acid, carboxylic esters, for example ethyl acetate and lactones such as butyrolactone, aliphatic and aromatic chlorohydrocarbons such as methylene chloride, chloroform, 1,2-dichloroethane or chlorobenzene, and mixtures of the above solvents.

Suitable solids contents of the solutions are in the concentration range of from 0.1 to 60% by weight, preferably between 0.5 and 50% by weight, especially preferably between 0.4 and 40% by weight. Suitable active substance contents are in the concentration range of from 0.01 to 60% by weight, preferably between 0.1 and 50% by weight, especially preferably between 0.1 and 40% by weight.

In a preferred embodiment, at least one active substance and, optionally, further additives, jointly or separately from one another, are added to the copolymer before the solvent or solvent mixture used for the polymerization reaction is removed. This means that the addition of the at least one active substance and, optionally, of further additives can take place before, during or after the polymerization reaction has ended. In an especially preferred embodiment, the active substance is added after the polymerization reaction has ended. Addition of the at least one active substance and, optionally, of further additives can be effected simultaneously, in a preceding step or in a subsequent step.

In a further preferred embodiment, at least one active substance and, optionally, further additives are added to the reaction mixture of the copolymer and of the solvent or solvent mixtures used after the polymerization has ended and dissolved or dispersed by known methods with which the skilled worker is familiar. In a particularly preferred embodiment, the at least one active substance is soluble in the solvent or solvent mixture used for the polymerization. Removal of the solvent takes place in a subsequent step by the above-described methods.

The invention also relates to an agrochemical active substance composition, comprising
(A) at least one random radical copolymer according to the invention and
(B) at least one agrochemical active substance.

Preferred, especially preferred and particularly preferred as component (A) are the abovementioned preferred, especially preferred and particularly preferred copolymers, in particular their embodiments with one or two monomers as component (b2).

Preferred, especially preferred and particularly preferred are the combinations of the preferred, especially preferred and particularly preferred copolymers with the preferred, especially preferred and particularly preferred active substances mentioned in each case hereinbelow.

Suitable active substance contents are in the concentration range of from 0.001 to 90% by weight, preferably between 0.01 and 80% by weight, especially preferably between 0.1 and 70% by weight (in each case based on the total composition).

According to the invention, the amount of the at least one copolymer is chosen such that the ratio of the proportions by weight of active substance(s) to copolymer(s) is in the range of from 1:10 to 10:1, preferably in the range of from 1:4 to 4:1, especially preferably in the range of from 1:3 to 2:1.

Active substances which are sparingly soluble in water are preferred. Within the scope of the invention, sparingly soluble in water means a solubility of less than 1000 mg/I water, preferably less than 100 mg/I, in each case at a temperature of 20° C.

Suitable plant protectants are, for example, fungicides, insecticides and herbicides which are listed at http://www.hclrss.demon.co.uk/index_cn_frame.html (Index of common names). The following fungicides, herbicides and insecticides may be mentioned as being preferred:

Preferred fungicides comprise

Strobilurins
e.g., azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-(2,5-dimethylphenyloxymethyl)phenyl)-3-methoxyacrylate;

Carboxamides
carboxanilides, such as benalaxyl, benodanil, bixafen, fluopyram, isopyrazam, sedaxane, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoromethyl)biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide; N-(3′,4′,5′-trifluorobiphenyl-2-yl)-3-difluoromethyl-1-methyl-1H-pyrazole-4-carboxamide, N-[2-(4′-trifluoromethylthio)biphenyl]-3-difluoromethyl-1-methyl-1H-pyrazole-4-carboxamide, N-[2-(1,3-dimethylbutyl)phenyl]-1,3-dimethyl-5-fluoro-1H-pyrazole-4-carboxamide, N-(2-bicyclopropyl-2-ylphenyl)-3-difluoromethyl-1-methyl-1H-pyrazole-4-carboxamide, N-(cis-2-bicyclopropyl-2-ylphenyl)-3-difluoromethyl-1-methyl-1H-pyrazole-4-carboxamide, N-(trans-2-bicyclopropyl-2-ylphenyl)-3-difluoromethyl-1-methyl-1H-pyrazole-4-carboxamide, N-[1,2,3,4-tetrahydro-9-(1-methylethyl)-1,4-methanonaphthalin-5-yl]-3-difluoromethyl-1-methyl-1H-pyrazole-4-carboxamide;
carboxylic acid morpholides, such as dimethomorph, flumorph;
benzamides, such as flumetover, fluopicolide (picobenzamid), zoxamide;
other carboxamides, such as carpropamid, diclocymet, mandipropamid, ethaboxam, N-(2-(4-[3-(4-chlorophenyl)prop-2-ynyloxy]-3-methoxyphenyl)ethyl)-2-methylsulfonylamino-3-methylbutyramide, N-(2-(4-[3-(4-chlorophenyl)prop-2-ynyloxy]-3-methoxyphenyl)ethyl)-2-ethylsulfonylamino-3-methylbutyramide;

Azoles (DMI)
triazoles, such as bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles, such as cyazofamid, imazalil, pefurazoate, prochloraz, triflumizole;
benzimidazoles, such as benomyl, carbendazim, fuberidazole, thiabendazole; and others, such as etridiazole, hymexazole;

Nitrogen-comprising heterocyclyl compounds, e.g.,
pyridines, such as fluazinam, pyrifenox, 3-[5-(4-chlorophenyl)-2,3-dimethylisoxazolidin-3-yl]pyridine;
pyrimidines, such as bupirimate, cyprodinil, ferimzone, fenarimol, mepanipyrim, nuarimol, pyrimethanil;
piperazines, such as triforine;
pyrroles, such as fludioxonil, fenpiclonil;
morpholines, such as aldimorph, dodemorph, fenpropimorph, tridemorph;
dicarboximides, such as iprodione, procymidone, vinclozolin;
others, such as acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 6-aryl-[1,2,4]triazolo[1,5-a]pyrimidines, e.g. 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;

Carbamates and dithiocarbamates
dithiocarbamates, such as ferbam, mancozeb, maneb, metiram, metam, propineb, thiram, zineb, ziram;
carbamates, such as diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethylsulfonyl)but-2-yl)carbamate;

Other fungicides
guanidines, such as dodine, iminoctadine, guazatine;
antibiotics, such as kasugamycin, polyoxins, streptomycin, validamycin A;
organometallic compounds, such as fentin salts;
sulfur-comprising heterocyclyl compounds, such as isoprothiolane, dithianon;
organophosphorus compounds, such as edifenphos, fosetyl, fosetyl-aluminum, iprobenfos, pyrazophos, tolclofos-methyl, phosphorous acid and its salts;
organochlorine compounds, such as thiophanate-methyl, chlorothalonil, dichlofluanid, tolylfluanid, flusulfamide, phthalide, hexachlorobenzene, pencycuron, quintozene;
nitrophenyl derivatives, such as binapacryl, dinocap, dinobuton;
others, such as spiroxamine, cyflufenamid, cymoxanil, metrafenon.

Preferred herbicidal active compounds comprise:
1,3,4-thiadiazoles, such as buthidazole and cyprazole;
amides, such as allidochlor, benzoylpropethyl, bromobutide, chlorthiamid, dimepiperate, dimethenamid, diphenamid, etobenzanid, flamprop-methyl, fosamine, isoxaben, metazachlor, monalide, naptalam, pronamide, propanil;
aminophosphoric acids, such as bilanafos, buminafos, glufosinate-ammonium, glyphosate, sulfosate;
aminotriazoles, such as amitrole;
anilides, such as anilofos, mefenacet;
aryloxyalkanoic acids, such as 2,4-D, 2,4-DB, clomeprop, dichlorprop, dichlorprop-P, fenoprop, fluroxypyr, MCPA, MCPB, mecoprop, mecoprop-P, napropamide, naproanilide, triclopyr;
benzoic acids, such as chloramben, dicamba;
benzothiadiazinones, such as bentazon;
bleachers, such as clomazone, diflufenican, fluorochioridone, flupoxam, fluridone, pyrazolate, sulcotrione;
carbamates, such as carbetamide, chlorbufam, chlorpropham, desmedipham, phenmedipham, vernolate;
quinolinic acids, such as quinclorac, quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb acetate, dinoterb, DNOC, minoterb acetate;
diphenyl ethers, such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen, oxyfluorfen;
dipyridyls, such as cyperquat, difenzoquat methylsulfate, diquat, paraquat dichloride;
imidazoles, such as isocarbamid;
imidazolinones, such as imazamethapyr, imazapyr, imazaquin, imazethabenz-methyl, imazethapyr, imazapic, imazamox;
oxadiazoles, such as methazole, oxadiargyl, oxadiazone;
oxiranes, such as tridiphane;
phenols, such as bromoxynil, ioxynil;
phenoxyphenoxypropionates, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl, quizalofop-tefuryl;
phenylacetic acids, such as chlorfenac;
phenylpropionic acids, such as chlorfenprop-methyl;
ppi active compounds, such as benzofenap, flumiclorac-pentyl, flumioxazin, flumipropyn, flupropacil, pyrazoxyfen, sulfentrazone, thidiazimin;
pyrazoles, such as nipyraclofen;
pyridazines, such as chloridazon, maleic hydrazide, norflurazon, pyridate;
pyridinecarboxylic acids, such as clopyralid, dithiopyr, picloram, thiazopyr;
pyrimidyl ethers, such as pyrithiobac acid, pyrithiobac-sodium, KIH-2023, KIH-6127;
sulfonamides, such as flumetsulam, metosulam;
triazolecarboxamides, such as triazofenamide;
uracils, such as bromacil, lenacil, terbacil;
furthermore benazolin, benfuresate, bensulide, benzofluor, bentazon, butamifos, cafenstrole, chlorthal-dimethyl, cinmethylin, dichlobenil, endothall, fluorbentranil, mefluidide, perfluidone, piperophos, topramezone and prohexadione-calcium;
sulfonylureas, such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron;
herbicides of the cyclohexenone type, such as alloxydim, clethodim, cloproxydim, cycloxydim, sethoxydim and tralkoxydim. Very particularly preferred herbicidal active compounds of the cyclohexenone type are: tepraloxydim (cf. AGROW, No. 243, 11.3.95, page 21, caloxydim) and 2-(1-[2-{4-chlorophenoxy}propyloxyimino]butyl)-3-hydroxy-5-(2H-tetrahydrothiopyran-3-yl)-2-cyclohexen-1-one, and of the sulfonylurea type: N-(((4-methoxy-6-[trifluoromethyl]-1,3,5-triazin-2-yl)amino)carbonyl)-2-(trifluoro-methyObenzenesulfonamide.

Preferred insecticides comprise:
organo(thio)phosphates, such as acephate, azamethiphos, azinphos-ethyl, azinphos-methyl, cadusafos, chiorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isoxathion, malathion, mecarbam, methamidophos, methidathion, parathion-methyl, mevinphos, monocrotophos, naled, omethoate, oxydemeton-methyl, paraoxon, parathion, parathion-methyl, phenthoate, phorate, phosalone, phosmet, phosphamidon, phoxim, pirimiphos, pirimiphos-methyl, profenofos, propetamphos, prothiofos, pyraclofos, pyridaphenthion, quinalphos, sulfotep, suiprofos, tebupirimfos, temephos, terbufos, tetrachlorvinphos, thiometon, triazophos, trichlorfon, vamidothion;
carbamates, such as alanycarb, aldicarb, bendiocarb, benfuracarb, butocarboxim, butoxycarboxim, carbaryl, carbofuran, carbosulfan, ethiofencarb, fenobucarb, fenoxycarb, formethanate, furathiocarb, isoprocarb, methiocarb, methomyl, metolcarb, oxamyl, pirimicarb, propoxur, thiodicarb, thiofanox, triazamate, trimethacarb, XMC, xylylcarb;
pyrethroids, such as acrinathrin, allethrin, d-cis-trans-allethrin, d-trans-allethrin, bifenthrin, bioallethrin, bioallethrin S-cyclopentenyl, bioresmethrin, cycloprothrin, cyfluthrin, beta-cyfluthrin, cyhalothrin, lambda-cyhalothrin, gamma-cyhalothrin, cyphenothrin, cypermethrin, alpha-cypermethrin, beta-cypermethrin, theta-cypermethrin, zeta-cypermethrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, profluthrin, pyrethrin I and II, resmethrin, RU 15525, silafluofen, tau-fluvalinate, tefluthrin, tetramethrin, tralomethrin, transfluthrin, dimefluthrin, ZXI 8901;
arthropodal growth regulators: a) chitin synthesis inhibitors, e.g. benzoylureas, such as bistrifluron, chlorfluazuron, diflubenzuron, flucycloxuron, flufenoxuron, hexaflumuron, lufenuron, novaluron, noviflumuron, teflubenzuron, triflumuron, buprofezin, diofenolan, hexythiazox, etoxazole, clofentezine; b) ecdysone antagonists, such as chlormafenozide, halofenozide, methoxyfenozide, tebufenozide, azadirachtin; c) juvenile hormone mimetics, such as pyriproxyfen, hydroprene, kinoprene, methoprene, fenoxycarb; d) lipid biosynthesis inhibitors, such as spirodiclofen, spiromesifen, spirotetramat;
nicotine receptor agonists/antagonists: acetamiprid, clothianidin, dinotefuran, imidacloprid, nitenpyram, thiacloprid, thiamethoxam, nicotine, bensultap, cartap hydrochloride, thiocyclam, thiosultap-sodium and AKD1022;
GABA antagonists, such as acetoprole, chlordane, endosulfan, ethiprole, gamma-HCH (lindane), fipronil, vaniliprole, pyrafluprole, pyriprole, phenylpyrazole compound of the formula r¹

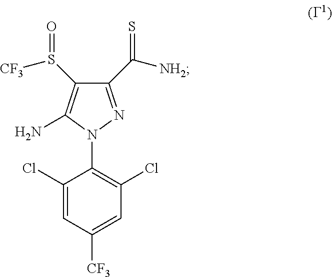 [SMILES: NC(=S)c1nn(-c2c(Cl)cc(C(F)(F)F)cc2Cl)c(N)c1S(=O)C(F)(F)F]

macrocyclic lactones, such as abamectin, emamectin, emamectin benzoate, milbemectin, lepimectin, spinosad;
METI I compounds, such as fenazaquin, fenpyroximate, flufenerim, pyridaben, pyrimidifen, rotenone, tebufenpyrad, tolfenpyrad;
METI II and III compounds, such as acequinocyl, fluacypyrim, hydramethylnon;
decoupling compounds, such as chlorfenapyr, DNOC;
inhibitors of oxidative phosphorylation, such as azocyclotin, cyhexatin, diafenthiuron, fenbutatin oxide, propargite, tetradifon;
molting inhibitors: cyromazine, chromafenozide, halofenozide, methoxyfenozide, tebufenozide;
synergists, such as piperonyl butoxide and tribufos;
sodium channel blockers, such as indoxacarb, metaflumizone;
selective antifeedants: cryolite, pymetrozine, flonicamid;
mite growth inhibitors: clofentezine, hexythiazox, etoxazole;
chitin synthesis inhibitors, such as buprofezin, bistrifluron, chlorfluazuron, diflubenzuron, flucycloxuron, flufenoxuron, hexaflumuron, lufenuron, novaluron, noviflumuron, teflubenzuron, triflumuron;
lipid biosynthesis inhibitors, such as spirodiclofen, spiromesifen, spirotetramat;
octopaminergic agonists, such as amitraz;
ryanodine receptor modulators, such as flubendiamide;
various: amidoflumet, benclothiaz, benzoximate, bifenazate, bromopropylate, cyenopyrafen, cyflumetofen, quinomethionate, dicofol, fluoroacetate, pyridalyl, pyrifluquinazon, N—R′-2,2-dihalo-1-R″-cyclopropanecarboxamide 2-(2,6-dichloro-α,α,α-trifluoro-p-tolyl)hydrazone, N—R′-2,2-di(R′″)propionamide 2-(2,6-dichloro-α,α,α-trifluoro-p-tolyl)hydrazone, in which R′ is methyl or ethyl, halo is chlorine or bromine, R″ is hydrogen or methyl and R′ is methyl or ethyl;
anthranilamides, such as chloranthraniliprole and cyantraniliprole
malononitrile compounds, such as CF₃(CH₂)₂C(CN)₂CH₂(CF₂)₃CF₂H, CF₃(CH₂)₂C(CH₂)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)malonodinitrile and CF₂HCF₂CF₂CF₂CH₂C(CN)₂CH₂CH₂CF₂CF₃;
pyrimidinyl alkynyl ethers of the formula Γ³ or thiadiazolyl alkynyl ethers of the formula Γ⁴:

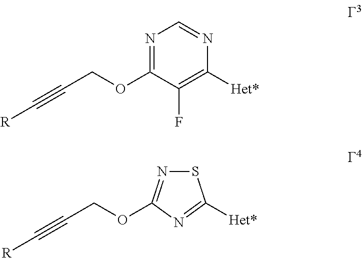

in which R is methyl or ethyl and Het* is 3,3-dimethylpyrrolidin-1-yl, 3-methylpiperidin-1-yl, 3,5-dimethylpiperidin-1-yl, 4-methylpiperidin-1-yl, hexahydroazepin-1-yl, 2,6-dimethylhexahydroazepin-1-yl or 2,6-dimethylmorpholin-4-yl. These compounds are described, for example, in JP 2006 131529.

Also preferred are mixtures of the abovementioned active substances, while, besides mixtures of various fungicides, herbicides and insecticides in each case with one another, mixtures of fungicides and insecticides are also particularly preferred.

In a preferred embodiment, the active substance is a fungicide, especially preferably selected from the groups of the
azoles, in particular
   triazoles, such as cyproconazole, epoxiconazole, fluquinconazole, hexaconazole, metconazole, penconazole, propiconazole, prothioconazole, tebuconazole and triticonazole, preferably epoxiconazole, metconazole, fluquinconazole and prothioconazole,
   imidazoles, such as cyazofamid, imazalil, pefurazoate, prochloraz and triflumizole, preferably prochloraz;
strobilurins, in particular azoxystrobin, dimoxystrobin, fluoxastrobin, kresoxim-methyl, metominostrobin, orysastrobin, picoxystrobin, pyraclostrobin and trifloxystrobin, preferably pyraclostrobin;
6-aryl-[1,2,4]triazolo-[1,5-a]-pyrimidines, for example 5-chloro-7-(4-methyl-piperidin-1-yl)-6-(2,4,6-trifluoro-phenyl)-[1,2,4]triazolo[1,5-a]pyrimidine;
carboxamides, in particular carboxanilides, in particular benalaxyl, benodanil, bixafen, boscalid, fluopyram, isopyrazam, sedaxane, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoromethyl)biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide; N-(3′,4′,5′-trifluorobiphenyl-2-yl)-3-difluoromethyl-1-methyl-1H-pyrazole-4-carboxamide, N-[2-(4′-trifluoromethylthio)biphenyl]-3-difluoromethyl-1-methyl-1H-pyrazole-4-carboxamide, N-[2-(1,3-dimethylbutyl)phenyl]-1,3-dimethyl-5-fluoro-1H-pyrazole-4-carboxamide, N-(2-bicyclopropyl-2-ylphenyl)-3-difluoromethyl-1-methyl-1H-pyrazole-4-carboxamide, N-(cis-2-bicyclopropyl-2-ylphenyl)-3-difluoromethyl-1-methyl-1H-pyrazole-4-carboxamide, N-(trans-2-bicyclopropyl-2-ylphenyl)-3-difluoromethyl-1-methyl-1H-pyrazole-4-carboxamide, N-[1,2,3,4-tetrahydro-9-(1-methylethyl)-1,4-methanonaphthalin-5-yl]-3-difluoromethyl-1-methyl-1H-pyrazole-4-carboxamide, ethaboxam and penthiopyrad;
morpholins, such as aldimorph, dodemorph, fenpropimorph, tridemorph, preferably fenpropimorph;
and mixtures of these active substances.

Especially preferred active substances are azole fungicides, in particular those mentioned, preferably also in a mixture with strobilurins, in particular those mentioned, and/or carboxamides, in particular those mentioned, and/or morpholins, in particular those mentioned.

Preferred are mixtures comprising two or more azole fungicides, in particular the abovementioned.

Also preferred are mixtures comprising at least one azole fungicide and at least one strobilurin, in particular the abovementioned.

Also preferred are mixtures comprising at least one azole fungicide and at least one morpholin, in particular the abovementioned.

Also preferred are mixtures comprising at least one azole fungicide, at least one strobilurin and at least one carboxamide, in particular those mentioned.

Also preferred are mixtures comprising at least one azole fungicide and a carboxamide, in particular those mentioned.

Besides one or more copolymers (A) and one or more active substances (B), the active substance compositions according to the invention also comprise, if appropriate, one or more solvents and/or diluents (component (C)) and/or one or more customary formulation auxiliaries (component (D)). Thus, solvents employed for example for the preparation of the copolymers and in the preparation of the formulations may be present in the formulation according to the invention.

In one embodiment, the formulations according to the invention may be present in the form of a liquid solution. Suitable solvents for preparing the active substance composition are, for example, mixtures of alkylaromatics, especially alkylbenzenes and alkylnaphthalenes which bear alkyl groups having 1 to 20 carbon atoms. Such mixtures are commercially available, for example Solvesso®, such as Solvesso 200 (Exxon Mobil, USA), aromatics, for example Aromatic 200 (Exxon Mobil), or Shellsol® products (Deutsche Shell Chemie GmbH, Germany). Other suitable organic solvents are paraffins, alcohols, pyrrolidones, acetates, glycols, fatty acids, dimethylamides, fatty acid dimethylamides, fatty acid esters, vegetable oils such as coconut oil, palm kernel oil, palm oil, soya oil, rapeseed oil, corn oil, and the methyl or ethyl esters of the abovementioned oils, and mixtures of these. Further suitable solvents are tributyl phosphate, methanol, ethanol, isopropanol, 1-butanol, 2-butanol, tert-butanol, pentanol, hexanol, 2-ethylhexanol, 1,3-dimethyl-2-imidazolinone, 2-methyl-2,4-pentanediol, acetone, acetophenone, propanoic acid, 2-hydroxy-2-ethyl hexyl ester, di-n-octyl carbonate, ethylene carbonate, propylene carbonate, butylene carbonate, dibasic esters such as dimethyl adipate, dimethyl succinate, dimethyl glutarate and their mixtures, or diisobutyl derivatives of benzyl acetate, benzyl alcohol, benzyl benzoate, cyclohexane, cyclohexanol, cyclohexanone, butyl lactate, 2-ethylhexyl lactate, ethyl lactate, methyl lactate, n-propyl lactate, tetrahydrofurfuryl alcohol, xylene, diethylene glycol, dimethylformamide, dimethyl sulfoxide, dipropylene glycol, 5-methyl-3-heptanone, glycols and derivatives such as, for example, polyethylene glycol, glycerol, propylene glycol, propylene glycol monomethyl ether acetate, dipropylene glycol monomethyl ether, propylene glycol monophenyl ether; butyrolactone, glycerol, methyl benzoate, n-ethyl-2-pyrrolidone, n-methylcaprolactam, n-octyl-2-pyrrolidone, propanoic acid, and ethers such as tetrahydrofuran and dioxane, water, and mixtures of these solvents, esters, ketones such as acetone, methyl ethyl ketone, methyl isopropyl ketone, methyl isobutyl ketone, acetals, ethers, cyclic ethers such as tetrahydrofuran, aliphatic carboxylic acids such as formic acid, acetic acid, propionic acid, carboxylic esters, for example ethyl acetate and lactones such as for example butyrolactone, aliphatic and aromatic chlorohydrocarbons such as methylene chloride, chloroform, 1,2-dichloroethane or chlorobenzene, and mixtures of the abovementioned solvents.

The abovementioned solvents are, in principle, also suitable for the preparation of emulsifiable concentrates (EC), water-dilutable concentrates (DC), oily suspensions, oil dispersions and similar formulations.

Solid formulations may be present in different macroscopic forms, with, for example, spray-dried powder, ground material, granules or film being mentioned.

Suitable diluents and inert carriers are, for example, mineral earths such as silica, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and vegetable products such as cereal meal, tree bark meal, wood meal and nutshell meal or cellulose powder.

In addition to these, the active substance compositions (i.e. the formulations and the aqueous application forms obtainable by dilution) may comprise, as component (D), conventional formulation auxiliaries in the amounts normally used for this purpose. These include, for example, agents for modifying the rheology (thickeners), antifoam agents, bactericides, antifreeze agents, pH control agents, stabilizers and plasticizers.

Suitable thickeners are compounds which confer a pseudoplastic flow behavior on aqueous compositions, i.e. high viscosity at rest and low viscosity in the agitated state. Mention may be made here for example of polysaccharides such as xanthan (Kelzan® from Kelco; Rhodopol® 23 from Rhone Poulenc; or Veegum® from R.T. Vanderbilt) and inorganic layered minerals such as Attaclay® (from Engelhardt), with xanthan being used by preference.

Suitable stabilizers may be low-molecular-weight components such as, for example, mono- and diglycerides, monoglyceride esters, alkyl glucosides, lecithin, fatty acid derivatives of urea and urethanes.

Suitable plasticizers are sucrose, glucose, lactose, fructose, sorbitol, mannitol or glycerol.

Antifoam agents which are suitable for the compositions according to the invention are, for example, silicone emulsions (such as, for example, Silikon® SRE, from Wacker, or Rhodorsil® from Rhodia), long-chain alcohols, fatty acids, fluoroorganic compounds, and their mixtures.

Bactericides may be added to stabilize the compositions according to the invention against attack by microorganisms. Typically, they are isothiazoline compounds, for example 1,2-benzoisothiazolin-3-one, 5-chloro-2-methylisothiazol-3-one, 2-methylisothiazol-3-one or 2-octylisothiazol-3-one, which are commercially available for example under the trade names Proxel® from Arch Chemical Inc., Acticide® RS from Thor Chemie and Kathon® MK from Rohm & Haas.

Suitable antifreeze agents are organic polyols, for example ethylene glycol, propylene glycol or glycerol. These are employed in aqueous formulations, usually in amounts of no more than 20% by weight, for example from 1 to 20% by weight, and in particular from 2 to 10% by weight, based on the total weight of the aqueous active substance formulation.

If appropriate, the active substance compositions may comprise from 1 to 5% by weight, based on the total amount of the prepared preparation, of agents for regulating the pH of the preparation or of the dilute application form, where the amount and nature of the agent employed depends on the chemical properties and on the amount of the active substances and of the copolymer (A). Examples of buffers are alkali metal salts of weak inorganic or organic acids such as, for example, phosphoric acid, boric acid, acetic acid, propionic acid, citric acid, fumaric acid, tartaric acid, oxalic acid and succinic acid.

Examples of conventional surface-active substances are the nonionic, anionic, cationic or zwitterionic emulsifiers, wetting agents or dispersants given below, e.g. the nonionic substances from groups b1) to b17):
b1) aliphatic C₈-C₃₀-alcohols, which can be alkoxylated, e.g. with from 1 to 60 alkylene oxide units, preferably from 1 to 60 EO and/or from 1 to 30 PO and/or from 1 to 15 BO, in any sequence. In this connection, EO is a repeating unit derived from ethylene oxide, PO is a repeating unit derived from propylene oxide and BO is a repeating unit derived from butylene oxide. The terminal hydroxyl groups of these compounds can be end group closed by an alkyl, cycloalkyl or acyl radical having from 1 to 24, in particular from 1 to 4, carbon atoms. Examples of such compounds are: Genapol®C, L, O, T, UD, UDD and X products from Clariant, Plurafac® and Lutensol®A, AT, ON, TO and M products from BASF SE, Marlipal® 24 and 013 products from Condea, Dehypon® products from Henkel and Ethylan® products from Akzo-Nobel, such as Ethylan CD 120;
b2) copolymers composed of EO, PO and/or BO units, in particular EO/PO block copolymers, such as the Pluronic® products from BASF SE and the Synperonic® products from Uniquema, with a molecular weight of from 400 to 10⁶ daltons, and also alkylene oxide adducts of C₁-C₉-alcohols, such as Atlox® 5000 from Uniquema or Hoe® S3510 from Clariant;
b3) fatty acid and triglyceride alkoxylates, such as the Serdox® NOG products from Condea, and also alkoxylated vegetable oils, such as soybean oil, rapeseed oil, corn oil, sunflower oil, cottonseed oil, linseed oil, coconut oil, palm oil, safflower oil, walnut oil, peanut oil, olive oil or castor oil, in particular rapeseed oil, for example the Emulsogen® products from Clariant;
b4) fatty acid amide alkoxylates, such as the Comperlan® products from Henkel or the Amam® products from Rhodia;
b5) alkylene oxide adducts of alkynediols, such as the Surfynol® products from Air Products. Sugar derivatives, such as amino- and amidosugars from Clariant. Glucitols from Clariant, alkylpolyglycosides in the form of the APG® products from Henkel or such as sorbitan esters in the form of the Span® or Tween® products from Uniquema or cyclodextrin esters or ethers from Wacker;
b6) surface-active cellulose and algin, pectin and guar derivatives, such as the Tylose® products from Clariant, the Manutex® products from Kelco and guar derivatives from Cesalpina;
b7) alkylene oxide adducts based on polyols, such as Polyglykol® products from Clariant;
b8) surface-active polyglycerides and the derivatives thereof from Clariant;
b9) sugar surfactants, e.g. alkoxylated sorbitan fatty acid esters, alkylpolyglycosides and the alkoxylated derivatives thereof;
b10) alkylene oxide adducts of fatty amines;
b11) surface-active compounds based on silicones or silanes, such as the Tegopren® products from Goldschmidt and the SE® products from Wacker, and also the Bevaloid®, Rhodorsil® and Silcolapse® products from Rhodia (Dow Corning, Reliance, GE, Bayer);
b12) per- or polyfluorinated surface-active compounds, such as the Fluowet® products from Clariant, the Bayowet® products from Bayer, the Zonyl® products from DuPont and products of this type from Daikin and Asahi Glass;
b13) surface-active sulfonamides, e.g. from Bayer;
b14) neutral surface-active polyvinyl compounds, such as modified polyvinyl-pyrrolidone, such as the Luviskol® products from BASF and the Agrimer® products from ISP, or derivatized polyvinyl acetates, such as the Mowilith® products from Clariant, or polyvinyl butyrates, such as the Lutonal® products from BASF, the Vinnapas® and the Pioloform® products from Wacker, or modified polyvinyl alcohols, such as the Mowiol® products from Clariant, and surface-active derivatives of montan, polyethylene and polypropylene waxes, such as the Hoechst® waxes or the Licowet® products from Clariant;
b15) poly- or perhalogenated phosphonates and phosphinates, such as Fluowet® PL from Clariant;
b16) poly- or perhalogenated neutral surfactants, such as, for example, Emulsogen® 1557 from Clariant;
b17) (poly)alkoxylated, in particular polyethoxylated, aromatic compounds, such as (poly)alkoxylated phenols [=phenol (poly)alkylene glycol ethers], for example with from 1 to 50 alkyleneoxy units in the (poly)alkyleneoxy part, the alkylene part preferably having from 2 to 4 carbon atoms each time, preferably phenol reacted with from 3 to 10 mol of alkylene oxide, (poly)alkylphenol alkoxylates [=polyalkylphenol (poly)alkylene glycol ethers], for example having from 1 to 12 carbon atoms per alkyl radical and from 1 to 150 alkyleneoxy units in the polyalkyleneoxy part, preferably tri(n-butyl)phenol or triisobutylphenol reacted with from 1 to 50 mol of ethylene oxide, polyarylphenols or polyarylphenol alkoxylates [=polyarylphenol (poly)alkylene glycol ethers], for example tristyrylphenol polyalkylene glycol ethers with from 1 to 150 alkyleneoxy units in the polyalkyleneoxy part, preferably tristyrylphenol reacted with from 1 to 50 mol of ethylene oxide, and the condensation products thereof with formaldehyde—preference is given among these to alkylphenol reacted with from 4 to 10 mol of ethylene oxide, available commercially, for example, in the form of the Agrisol® products (Akcros), triisobutylphenol reacted with from 4 to 50 mol of ethylene oxide, available commercially, for example, in the form of the Sapogenat® T products (Clariant), nonylphenol reacted with from 4 to 50 mol of ethylene oxide, available commercially, for example, in the form of the Arkopal® products (Clariant), or tristyrylphenol reacted with from 4 to 150 mol of ethylene oxide, for example from the Soprophor® series, such as Soprophor® FL, Soprophor® 3D33, Soprophor® BSU, Soprophor® 4D-384, Soprophor® CY/8 (Rhodia);
   the anionic substances from groups b18) to b24):
b18) anionic derivatives of the products described under b1) in the form of ether carboxylates, sulfonates, sulfates (=sulfuric acid hemiesters) and phosphates (phosphoric acid mono- or diesters) of the substances described under b1) and the inorganic salts (e.g., NH₄⁺, alkali metal and alkaline earth metal salts) and organic salts (e.g., based on amines or alkanolamines) thereof, such as Genapol®LRO, Sandopan® products, Hostaphat/Hordaphos® products from Clariant;
b19) anionic derivatives of the products described under b17) in the form of ether carboxylates, sulfonates, sulfates (=sulfuric acid hemiesters) and phosphates (phosphoric acid mono- or diesters) of the substances described under b17), for example the acidic phosphoric acid ester of a C₁-C₁₆-alkylphenol ethoxylated with from 2 to 10 mol of ethylene oxide, e.g. the acidic phosphoric acid ester of a nonylphenol reacted with 3 mol or with 9 mol of ethylene oxide, and the phosphoric acid ester, neutralized with triethanolamine, of the reaction product of 20 mol of ethylene oxide and 1 mol of tristyrylphenol;
b20) benzenesulfonates, such as alkyl- or arylbenzenesulfonates, e.g. (poly)alkyl- and (poly)arylbenzenesulfonates which are acidic and neutralized with suitable bases, for example having from 1 to 12 carbon atoms per alkyl radical or with up to 3 styrene units in the polyaryl radical, preferably (linear) dodecylbenzenesulfonic acid and the oil-soluble salts thereof, such as, for example, the calcium salt or the isopropylammonium salt of dodecylbenzenesulfonic acid, and acidic (linear) dodecylbenzenesulfonate, available commercially, for example, in the form of the Marlon® products (Hüls);
b21) lignosulfonates, such as sodium, calcium or ammonium lignosulfonates, such as Ufoxane® 3A, Borresperse AM® 320 or Borresperse® NA;
b22) condensation products of arylsulfonic acids, such as phenolsulfonic acid or naphthalenesuifonic acid, with formaldehyde and, if appropriate, urea, in particular the salts thereof and especially the alkali metal salts and calcium salts, e.g. the Tamol® and Wettol® brands from BASF SE, such as Wettol® Dl;
b23) salts of aliphatic, cycloaliphatic and olefinic carboxylic acids and polycarboxylic acids, and also α-sulfo fatty acid esters, such as are available from Henkel;
b24) alkanesulfonates, paraffinsulfonates and olefinsulfonates, such as Netzer IS®, Hoe® S1728, Hostapur® OS, Hostapur® SAS from Clariant;
   furthermore cationic and zwitterionic products from groups b25) and b26):
b25) quaternary ammonium compounds having from 8 to 22 carbon atoms (C₈-C₂₂), such as the Genamin® C, L, 0 and T products from Clariant;
b26) surface-active, zwitterionic compounds, such as taurides, betaines and sulfobetaines in the form of Tegotain® products from Goldschmidt, Hostapon®T and Arkopon®T products from Clariant.

Preference is given, among the alkyleneoxy units to ethyleneoxy, propyleneoxy and butyleneoxy units, in particular ethyleneoxy units and mixtures of ethyleneoxy units and propyleneoxy units. The term “alkoxylated” means that the surface-active substance exhibits a polyalkylene ether group, especially a poly-C₂-C₄-alkylene ether group, specifically a poly-C₂-C₃-alkylene ether group.

Formulations according to the invention are preferably those which are diluted with water before being applied.

The invention also relates to processes for the preparation of aqueous dispersions comprising an active substance formulation according to the invention, an aqueous system and optionally further additives, the formulation being brought into contact with an aqueous system and being dispersed in the customary manner.

An aqueous system is understood as meaning pure water or water comprising a buffer system or salts or further additives, for example water-miscible solvents or mixtures of these. The pH of the aqueous system is generally in the range of from 2 to 13, preferably from 3 to 12, especially preferably from 4 to 10.

Examples of formulations according to the invention are
aqueous formulations in which the active substance is present in suspended or dispersed form (known as SC formulations);
water-dilutable emulsifiable concentrates (known as EC formulations), in which the active substance is present as a solution in a water-immiscible solvent, for example a hydrocarbon or a vegetable oil or vegetable oil derivative, such as a vegetable oil methyl ester;
water-dilutable concentrates in which the active substance is present as a solution in a water-miscible solvent, for example a lactam, such as N-methylpyrrolidone, a lactone such as butyrolactone, a cyclic carbonate such as ethylene carbonate or propylene carbonate, an alkanol or alkanediol such as ethanol, propanol, propylene glycol or a mixture of these (known as DC formulations),
solid formulations such as powders or granules which are dilutable with water (i.e. which are water-soluble or dispersible) and which typically comprise a solid carrier;
dispersible concentrates;
emulsions;
suspensions;
water-dispersible and water-soluble granules and
gels.

If appropriate, the dispersions may comprise 1-5% by weight of buffer based on the total amount of the formulation prepared, so as to regulate the pH, the amount and nature of the buffer employed depending on the chemical properties of the active substance(s). Examples of buffers are alkali metal salts of weak inorganic or organic acids such as, for example, phosphoric acid, boric acid, acetic acid, propionic acid, citric acid, fumaric acid, tartaric acid, oxalic acid and succinic acid.

Preferred is the use of the plant protection formulations prepared according to the invention, in solid or dissolved form, for controlling harmful fungi in the agricultural sector, where at least one active substance must be dissolved.

The active substance compositions according to the invention are suitable for use in plant protection, preferably for controlling phytopathogenic microorganisms, in particular fungi, animal pests, in particular harmful anthropods such as insects and arachnids, and nematodes and harmful plants. Preferred is the use for controlling phytopathogenic microorganisms, in particular fungi.

The invention furthermore relates to a method for controlling harmful organisms from the group of the phytopathogenic microorganisms, in particular fungi, animal pests, in particular harmful anthropods such as insects and arachnids, and nematodes and harmful plants, where the harmful organisms, their environment, or the plants, areas, materials or spaces to be protected, are treated with an active substance composition according to the invention, preferably in an effective amount.

Preferred is a method for controlling phytopathogenic microorganisms, in particular fungi.

The active substance composition according to the invention is also suitable for the treatment of seed.

A further field of application is animal health, where the active substance composition according to the invention is suitable for use in a method for controlling parasites of animals, where the animal is treated with the active substance composition, preferably in an effective amount.

Active substance compositions according to the invention are furthermore suitable for the preparation of a veterinary pharmaceutical, in particular for controlling parasites.

The invention is illustrated in greater detail by the examples, without being limited thereby.

### EXAMPLES

### A Synthesis examples

### Synthesis Example 1

### Preparation of a Random Radical Copolymer A.1

150.00 g of isopropanol were heated to 70° C., with stirring, in a 2 l polymerization reactor equipped with reflux condenser. Within 3.5 h, both a solution of 58.25 g of methyl methacrylate (MMA), 19.81 g of dodecyl acrylate (DDA) and 38.45 g of 2-acrylamido-2-methyl-1-propanesulfonic acid (AMPS) in a mixture of 45.33 g of water and 438.33 g of isopropanol and a solution of 3.50 g of 2,2′-azobis(isobutyronitrile) (AIBN) in 45.33 g of tetrahydrofuran (THF) were fed slowly and uniformly to the mixture via separate feeds. The reaction mixture was stirred for a further 16 h while maintaining the internal temperature (70° C.). Thereafter, no residual monomers were detectable. The slightly turbid, colorless mixture was filtered and the filtrate was freed from the solvents in vacuo. The copolymer A.1 (Mₙ=5400 g/mol; M_{w}=14 600 g/mol) was obtained in the form of a colorless amorphous solid. The glass transition temperature of the copolymer was 55° C.

### Synthesis Example 2

### Preparation of a Random Radical Copolymer A.2

A mixture of 35.50 g of water and 67.48 g of isopropanol were heated to 75° C., with stirring, in a 2 l polymerization reactor equipped with reflux condenser. Within 3 h, a solution of 71.61 g MMA, 9.39 g of DDA, 7.59 g TDA and 54.41 g of AMPS in a mixture of 64.90 g of water and 357.60 g of isopropanol and simultaneously within 3.5 h a solution of 6.77 g of 2,2′-azobis(2-methylpropionamidine) dihydrochloride (WAKO V-50) in 327.50 g of water were fed slowly and uniformly to the mixture via separate feeds. After the last feed had ended, the reaction mixture was stirred for a further 6.5 h while maintaining the internal temperature (75° C.). Thereafter, no residual monomers were detectable. The slightly turbid, colorless mixture was filtered and the filtrate was freed from the solvents in vacuo. The copolymer A.2 (Mₙ=5300 g/mol; M_{w}=12 000 g/mol) was obtained in the form of a colorless amorphous solid. The glass transition temperature of the copolymer was 101° C.

### Characterization of the Copolymers According to the Invention

The molar masses of the copolymers A.1 and A.2 were determined by means of size-exclusion chromatography. The eluent used was dimethylacetamide, treated with 0.5% of lithium bromide; polymethyl methacrylate calibration samples were used as calibration system.

TABLE 1
Molar masses and glass transition temperatures of copolymers A.1
and A.2 according to the invention.

| | | Initiator/ | | | | |
|---|---|---|---|---|---|---|
| Polymer | Solvent | Regulator* | Mₙ | M_{w} | PD | T_{g} |
| A.1 | H₂O/ | AIBN/— | 5400 | 14 600 | 2.7 | 55° C. |
| AMPS/MMA/ | i-PrOH/ | | | | | |
| DDA | THF | | | | | |
| 33/50/17% by | | | | | | |
| weight | | | | | | |
| A.2 | H₂O/ | V-50/— | 5300 | 12 000 | 2.3 | 101° C. |
| AMPS/MMA/ | i-PrOH | | | | | |
| DDA/TDA | | | | | | |
| 38/50/7/5% | | | | | | |
| by weight | | | | | | |

*WAKO ® V-50 = 2,2′-Azobis(2-methylpropionamidine) dihydrochloride AIBN = 2,2′-Azobis(isobutyronitrile) AMPS = 2-Acrylamido-2-methyl-1-propanesulfonic acid MMA = Methyl methacrylate DDA = Dodecyl acrylate TDA = Tetradecyl acrylate THF = Tetrahydrofuran i-PrOH = Isopropanol

### B Use Examples

### Fungicidal Action of Active Substance Compositions According to the Invention

Curative Activity Against Leaf Rust of Wheat Caused by Puccinia recondita

Leaves of pot-grown wheat seedlings cv. “Kanzler” were inoculated with a spore suspension of leaf rust (Puccinia recondita). Thereafter, the pots were placed for 24 hours into a chamber with high atmospheric humidity (90 to 95%) and 20 to 22° C. During this time, the spores germinated, and the germinal tubes penetrated the leaf tissue. On the next day, the infected plants were sprayed to runoff point with the active substance compositions described in table 2 at the active substance concentration detailed hereinbelow. After the spray coating had dried on, the test plants were grown for 7 days in the greenhouse at temperatures of between 20 and 22° C. and 65 to 70% relative atmospheric humidity. Then, the extent of the rust fungus development on the leaves was determined.

The fungicidal action of different formulations of plant protectant as a function of the concentration of active substance applied is assessed in table 2 hereinbelow.

The columns “composition formulation” and “active substance concentration in formulation” indicate the qualitative and quantitative composition of the formulation in question. The weight ratio of polymer to active substance was 2:1 for all formulations.

The column “active substance concentration in spray mixture” indicates the concentration at which the active substance or the active substance mixture was applied.

The column “score” indicates, on a scale from 0 to 100, the fungal infestation which remains after the treatment, the number 100 indicating complete infestation. The value shown is a mean of 3 individual values.

TABLE 2
Fungicidal action of selected formulations according to the
invention as a function of the active substance concentration

| | | Active substance | Active substance | |
|---|---|---|---|---|
| | | concentration | concentration | |
| | Compostition of | in formulation(% | in spray | Score (mean of |
| Examples | the formulation | by weight) | mixture [ppm] | measurements) |
| F-1 | A.1 + | 30 | 50 | 11 |
| | metconazole/epoxiconazole | | 25 | 32 |
| | (3:2) + 10% | | 12.5 | 55 |
| | naphthalenesulfonic acid | | | |
| | formaldehyde condensate | | | |
| F-2 | A.2 + | 30 | 50 | 8 |
| | metconazole/epoxiconazole | | 25 | 22 |
| | (3:2) + 10% | | 12.5 | 50 |
| | naphthalenesulfonic acid | | | |
| | formaldehyde condensate | | | |
| F-3 | A.1 + | 30 | 64 | 15 |
| | epoxiconazole/pyraclostrobin | | 16 | 65 |
| | (5:7) + 10% | | 4 | |
| | naphthalenesulfonic acid | | | |
| | formaldehyde condensate | | | 70 |
| F-4 | A.2 + | 30 | 64 | 7 |
| | epoxiconazole/pyraclostrobin | | 16 | 35 |
| | (5:7) + 10% | | 4 | |
| | naphthalenesulfonic acid | | | |
| | formaldehyde condensate | | | 73 |
| Comparison | Untreated | 0 | 0 | 85 |
| K-1 | | | | |
| Comparison | A.1 | 0 | 0 | 80 |
| K-2 | | | | |
| Comparison | A.2 | 0 | 0 | 76 |
| K-3 | | | | |

1-20. (canceled)

21. A process for preparing a random radical copolymer comprising dissolving
a) at least one olefinically unsaturated sulfonic acid of the formula (I), 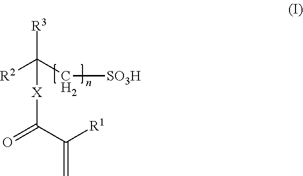
where
n is 0 to 10;
X is O or NR⁵;
R¹ is hydrogen or methyl;
R², R³ independently of one another are hydrogen or C₁- to C₆-alkyl and
R⁵ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
salts thereof or mixtures of acid and salts and
b) at least two structurally different olefinically unsaturated monomers of the formula (II), 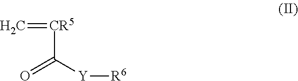
where
Y is O or NR⁷;
R⁵ is hydrogen or methyl;
R⁶ is alkyl, hydroxyalkyl, (di)alkylaminoalkyl or (di)alkylaminoaryl and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
and
c) if appropriate, one or more olefinically unsaturated monomers which differ structurally from components (a) and (b), and
d) at least one initiator
either in (i) a solvent mixture comprising water and a water-soluble organic solvent with a boiling point of less than 140° C. or (ii) in one or more pure alcohols by heating, and polymerizing the monomer to afford the random copolymer.

22. The process of claim 21, carried out as described in variant (i).

23. The process of claim 21, carried out as described in variant (ii).

24. The process of claim 21, wherein component (a) is dissolved by heating in water or a solvent mixture comprising water and a water-soluble organic solvent with a boiling point of less than 140° C. or in one or more pure alcohols and the solution is mixed with components (b), (c) and (d), dissolved in identical or different water-soluble organic solvents with a boiling point of less than 140° C., and the mixture is polymerized.

25. The process of claim 21, wherein component (a) is dissolved in water or a solvent mixture comprising water and a water-soluble organic solvent with a boiling point of less than 140° C. in order to prepare a solution of component (a), and components (b), (c) and (d) are dissolved in a combined or several separate solutions in at least one water-soluble organic solvent with a boiling point of less than 140° C. and mixed with the solution of component (a), and the mixture is polymerized.

26. The process of claim 21, wherein component (a) is dissolved by heating in one or more pure alcohols in order to prepare a solution of component (a), and components (b), (c) and (d) are dissolved in a combined or several separate solutions in at least one water-soluble organic solvent with a boiling point of less than 140° C. and mixed with the solution of component (a), and the mixture is polymerized.

27. The process of claim 21, wherein the random copolymer is obtained by polymerizing
a) at least one olefinically unsaturated sulfonic acid of the formula (I), 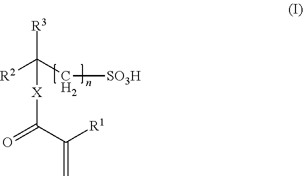
wherein
X is NH or oxygen;
R¹ is methyl or hydrogen;
R² and R³ are methyl or hydrogen and
n is 1,
salts thereof or mixtures of acid and salts, and
b1) at least one olefinically unsaturated monomer of the formula (Ha), 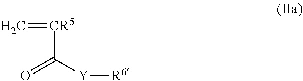
where
Y is oxygen or NR⁷;
R⁵ is hydrogen or methyl;
R^{6′} is C₁-C₆-alkyl and
R⁷ is hydrogen, alkyl, aryl, alkylaryl, arylalkyl, alkoxyalkyl, aryloxyalkyl, alkoxyaryl, hydroxyalkyl, (di)alkylaminoalkyl, (di)alkylaminoaryl, (di)arylaminoalkyl, alkylarylaminoalkyl or alkylarylaminoaryl, it being possible for the aryl radicals to be monosubstituted or polysubstituted,
b2) at least one olefinically unsaturated monomer of the formula (IIb), 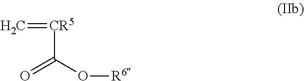
wherein
R⁵ is methyl or hydrogen and
R^{6″} is C₇-C₂₀-alkyl
and
c) if appropriate, at least one further olefinically unsaturated monomer which differs structurally from both components b1 and b2, wherein the copolymer shows an average molecular weight Mw in the range of from 2,000 to 15,000;
wherein at least two structurally different monomers b2 are employed for the polymerization.

28. The process of claim 27, wherein
(a) the at least one olefinically unsaturated sulfonic acid of the formula (I) is selected from the group consisting of acrylamido-2-methyl-1-propanesulfonic acid (AMPS) and 2-sulfoethyl methyl acrylate (SEMA), salts of these or mixtures of acid and salts, and
(b1) the at least one olefinically unsaturated monomer of the formula (IIa) is a compound of the formula (IIa)
in which
Y is oxygen or NR⁷;
R⁵ is hydrogen or methyl;
R^{6′} is (C₁-C₄)-alkyl and
R⁷ is hydrogen or (C₁-C₆)-alkyl;
(b2) the at least one olefinically unsaturated monomer of the formula (IIb) is a compound of formula (IIb)
in which
R⁵ is hydrogen or methyl and
R^{6″} is (C₁₀-C₂₀)-alkyl;
and (c) the optional further olefinically unsaturated monomer is acrylic acid, methacrylic acid, or mixtures thereof.

29. The process of claim 27, wherein
(a) the at least one olefinically unsaturated sulfonic acid of the formula (I) is selected from the group consisting of acrylamido-2-methyl-1-propanoic acid (AMPS) and 2-sulfoethyl methyl acrylate (SEMA),
(b1) the at least one olefinically unsaturated monomer of the formula (IIa) is a compound of formula (IIa), in which
Y is oxygen;
R⁵ is hydrogen or methyl and
R^{6′} is (C₁-C₄)-alkyl;
(b2) the at least one olefinically unsaturated monomer of the formula (IIb) is a compound of formula (IIb), in which
R⁵ is hydrogen or methyl and
R^{6″} is decyl, dodecyl, tetradecyl, hexadecyl, octadecyl or eicosyl;
and (c) the optional further olefinically unsaturated monomer is acrylic acid, methacrylic acid, or mixtures thereof.

30. The process of claim 27, wherein
(a) the at least one olefinically unsaturated sulfonic acid of the formula (I) is selected from the group consisting of acrylamido-2-methyl-1-propanoic acid (AMPS) and 2-sulfoethyl methyl acrylate (SEMA),
(b1) the at least one olefinically unsaturated monomer of the formula (IIa) is a compound of formula (IIa), in which
Y is oxygen;
R⁵ is methyl and
R^{6′} is (C₁-C₄)-alkyl;
(b2) is from among compounds of the formula (IIb), in which
R⁵ is hydrogen and
R^{6″} is dodecyl, tetradecyl, hexadecyl or octadecyl;
and (c) the optional further olefinically unsaturated monomer is acrylic acid, methacrylic acid, or mixtures thereof.

31. The process of claim 27, wherein the monomer component (I) employed is a sulfonic acid salt and the acid groups of the copolymer are partially or fully protonated in a subsequent step.

32. A process for the preparation of an agrochemical active substance composition, comprising dissolving, separately from one another in identical or different solvents, one or more copolymers of claim 27 and at least one plant protectant and, if appropriate, further additives and mixing the resulting solutions with one another, if appropriate, with addition of further additives.
